(19) United States
(12) Patent Application Publication
(10) Pub. No.: US 2026/0327811 A1
(43) Pub. Date: Oct. 22, 2026

(54) FUEL GENERATOR

(71) Applicant: Hana Green Energy Hydrogen Systems Research, Inc., Hana, HI (US)

(72) Inventor: Dale G. BASGALL, Hana, HI (US)

(21) Appl. No.: 19/468,157

(22) Filed: Feb. 3, 2026

Related U.S. Application Data
(60) Provisional application No. 63/754,373, filed on Feb. 5, 2025.

(51) Int. Cl. C25B 1/04; C25B 15/08; H02S 10/20

(52) U.S. Cl. CPC C25B 1/04; C25B 15/083; H02S 10/20

(57) ABSTRACT

A fuel generator is provided herein. The fuel generator comprises an electrical conductor, a hollow tube electrically connected to the electrical conductor, and a rod electrically connected to the electrical conductor. The rod is positioned within the hollow tube, and the rod and the hollow tube are electrically isolated from each other. The fuel generator further comprises a fluid port operatively connected to the hollow tube, wherein the fluid port is configured to allow water to enter a space between the rod and the hollow tube. The fuel generator also comprises a chamber operatively connected to the space between the rod and the hollow tube, wherein the chamber is configured to receive gas generated within the hollow tube.

### CROSS-REFERENCE TO RELATED APPLICATION

This application claims the benefit of U.S. Provisional Patent Application No. 63/754,373, filed Feb. 5, 2025, and titled “FUEL GENERATOR.” The entirety of which is incorporated herein by reference.

### TECHNICAL FIELD

The present technology generally relates to a fuel generator that relates to electrolyzers that disassociate H₂O into the gas elements hydrogen and oxygen.

### BACKGROUND

Heating fuel energy that is produced from sunlight charging a battery is considered green energy. Production of such energy reduces carbon emissions relative to conventional energy sources. The equipment and machinery currently available to purchase all fall short of producing heating gas fuel for individuals.

For example, presently, there is a lack of portable electrolyzers for use by individuals in a home or camping situation to generate and deliver useable heating fuel. Currently available electrolyzers are large, expensive, and not intended as portable apparatus. Such electrolyzers consist of internal flat plates that are cascaded and isolated in series fashion. Such electrolyzers are not intended to be taken apart by the end user and cannot be rebuilt easily.

It would be advantageous to provide sun powered hydrogen fuel generators for individual consumers that can deliver sufficient heating fuel to allow the individuals or families to produce their own heating fuel.

### SUMMARY OF THE INVENTION

Embodiments of the invention comprise a fuel generator that generally relates to an electrolyzer which uses electrolysis methods to disassociate water into its molecular components of hydrogen and oxygen.

### BRIEF DESCRIPTION OF THE DRAWINGS

Many aspects of the present technology can be better understood with reference to the following drawings. The components in the drawings are not necessarily to scale. Instead, emphasis is placed on illustrating clearly the principles of the present disclosure.

FIG. 1 is a block diagram showing an electrolyzer used to produce hydrogen and oxygen gas, in accordance with one or more embodiments;

FIG. 2 is perspective view of a fuel generator system, in accordance with one or more embodiments;

FIG. 3 is a cross-sectional view of the gas transfer location of a fuel generator system, in accordance with one or more embodiments;

FIG. 4 is a cross-sectional view of a disassembled fuel generator system, in accordance with one or more embodiments;

FIG. 5A is a perspective view of Plate 1 of a fuel generator system, in accordance with one or more embodiments;

FIG. 5B is a perspective view of Plate 1 of a fuel generator system, in accordance with one or more embodiments;

FIG. 5C is a top view of Plate 1 of a fuel generator system, in accordance with one or more embodiments;

FIG. 5D is a bottom view of a Plate 1 of a fuel generator system, in accordance with one or more embodiments;

FIG. 5E is a cross-sectional view of Plate 1 of a fuel generator system, in accordance with one or more embodiments;

FIG. 5F is a perspective view of Plate 1 of a fuel generator system, in accordance with one or more embodiments;

FIG. 5G is a cross-sectional view of Plate 1 of a fuel generator system, in accordance with one or more embodiments;

FIG. 6A is a perspective view of Plate 2 of a fuel generator system, in accordance with one or more embodiments;

FIG. 6B is a perspective view of Plate 2 of a fuel generator system, in accordance with one or more embodiments;

FIG. 6C is a top view of Plate 2 of a fuel generator system, in accordance with one or more embodiments;

FIG. 6D is a bottom view of a Plate 2 of a fuel generator system, in accordance with one or more embodiments;

FIG. 6E is a cross-sectional view of Plate 2 of a fuel generator system, in accordance with one or more embodiments;

FIG. 6F is a perspective view of Plate 2 of a fuel generator system, in accordance with one or more embodiments;

FIG. 6G is a cross-sectional view of Plate 2 of a fuel generator system, in accordance with one or more embodiments;

FIG. 7A is a perspective view of Plate 3 of a fuel generator system, in accordance with one or more embodiments;

FIG. 7B is a perspective view of Plate 3 of a fuel generator system, in accordance with one or more embodiments;

FIG. 7C is a top view of Plate 3 of a fuel generator system, in accordance with one or more embodiments;

FIG. 7D is a bottom view of a Plate 3 of a fuel generator system, in accordance with one or more embodiments;

FIG. 7E is a cross-sectional view of Plate 3 of a fuel generator system, in accordance with one or more embodiments;

FIG. 7F is a perspective view of Plate 3 of a fuel generator system, in accordance with one or more embodiments;

FIG. 7G is a cross-sectional view of Plate 3 of a fuel generator system, in accordance with one or more embodiments;

FIG. 8A is a perspective view of Plate 4 of a fuel generator system, in accordance with one or more embodiments;

FIG. 8B is a perspective view of Plate 4 of a fuel generator system, in accordance with one or more embodiments;

FIG. 8C is a top view of Plate 5 of a fuel generator system, in accordance with one or more embodiments;

FIG. 8D is a bottom view of a Plate 4 of a fuel generator system, in accordance with one or more embodiments;

FIG. 8E is a cross-sectional view of Plate 4 of a fuel generator system, in accordance with one or more embodiments;

FIG. 8F is a perspective view of Plate 4 of a fuel generator system, in accordance with one or more embodiments;

FIG. 8G is a cross-sectional view of Plate 4 of a fuel generator system, in accordance with one or more embodiments;

FIG. 9A is a perspective view of hollow tube for a fuel generator system, in accordance with one or more embodiments;

FIG. 9B is a perspective view of a rod for a fuel generator system, in accordance with one or more embodiments;

FIG. 9C is a perspective view of an electrical conductor for a fuel generator system, in accordance with one or more embodiments;

FIG. 10 is a cross-sectional view of a fuel generator system comprising multiple filtration systems, in accordance with one or more embodiments;

FIG. 11A is a cross-sectional view of an assembled filtration system, in accordance with one or more embodiments;

FIG. 11B is a cross-sectional view of a disassembled filtration system, in accordance with one or more embodiments;

FIG. 12 is a series of perspective views of the filtration body of a filtration system, in accordance with one or more embodiments;

FIG. 13A is a series of perspective views of the filtration plug of a filtration system, in accordance with one or more embodiments;

FIG. 13B is a series of perspective views of the filtration plug of a filtration system, in accordance with one or more embodiments;

FIG. 14 is a cross-sectional view of the locking mechanism of a filtration system, in accordance with one or more embodiments;

FIG. 15 is a flowchart depicting a method of generating fuel, in accordance with one or more embodiments; and

FIG. 16 is a flowchart depicting a method of filtering a fluid, in accordance with one or more embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Conventional fuel generation systems present significant challenges for individuals seeking to produce heating fuel on demand, particularly during emergency situations or in geographically isolated locations. Natural disasters can disrupt supply chains and leave communities without access to propane or other heating fuels for extended periods. Remote areas, such as isolated island communities, often depend on imported fuel that must travel long distances by ship and truck. When supply disruptions occur, residents may face multi-hour drives to obtain fuel or simply go without. These limitations create critical vulnerabilities for individuals and families who cannot reliably access heating fuel when they need it most.

Current electrolyzer technology fails to meet the needs of individual consumers who want to generate their own heating fuel at home. Existing electrolyzers are large, expensive, and designed for industrial applications rather than household use. These systems consist of large internal flat plates cascaded and isolated in series fashion, making them complex to operate and maintain. Due to their complexity, the average consumer cannot easily take apart, clean, or rebuild these devices when problems arise. This lack of user-serviceable design forces consumers to rely on professional technicians for even basic maintenance tasks, increasing costs and reducing accessibility.

The manufacturing complexity of conventional electrolyzer systems creates additional barriers to widespread adoption. Traditional designs require numerous diverse parts and specialized manufacturing processes that limit production to facilities with advanced capabilities. The cascaded plate architecture demands precise alignment and sealing across multiple components, increasing both manufacturing difficulty and cost. These complex designs require custom or specialized industrial tools, restricting production to specialized manufacturers and preventing a dependable consumer product.

The present disclosure addresses the on-demand fuel generation problem through a portable electrolyzer that produces heating fuel using readily available resources. The system operates with water, such as ocean water, and connects to common electrical energy sources including solar panels, car batteries, or other DC power supplies. This configuration allows users to generate hydrogen and oxygen gas for heating purposes without depending on external fuel supply chains. The portable design enables deployment in remote locations, emergency situations, or anywhere traditional fuel access is limited or unavailable.

The fuel generator disclosed herein provides a consumer-friendly design that enables easy storage, assembly, and operation by individuals without specialized training. Some embodiments measure approximately sixteen inches by sixteen inches and include a base support for convenient and stable positioning. In some embodiments, the fuel generator comprises four disk plates that users can assemble and disassemble using connection rods, studs, and nuts. This modular construction allows consumers to replace worn parts, store the device compactly when not in use, and perform cleaning or repairs without professional assistance. The straightforward assembly process puts fuel generation capability directly in the hands of consumers.

Some embodiments of the present invention achieve manufacturing simplicity through a design that uses commonly available materials and standard fabrication techniques. The fuel generator can be constructed from a solid aluminum bar, a tube, a rod, and a modified spark plug. A standard machine shop can produce all necessary components using a lathe to cut cooling grooves, a mill to drill holes and cut bores, and a band saw to separate the disk plates. Alternatively, the fuel generator can be fabricated using an industrial 3D printer. This accessible manufacturing approach enables production anywhere standard machining equipment exists, reducing costs and expanding availability to consumers worldwide.

### Electrolyzer System

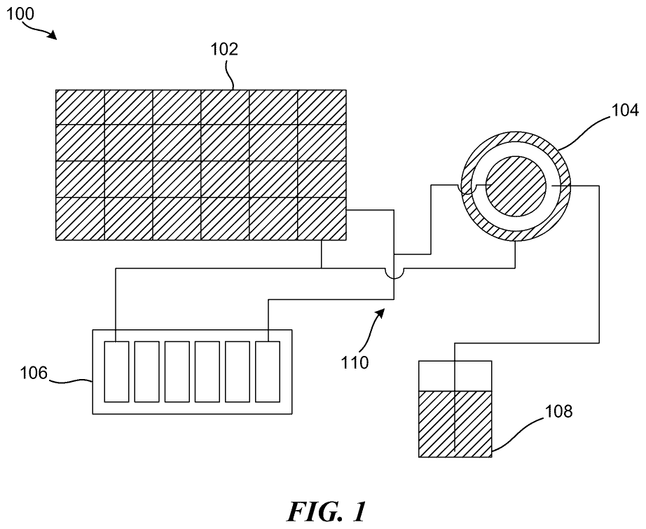

In some embodiments, such as illustrated in FIG. 1, an electrolyzer system 100 comprises an electrical energy source 102, an electrolyzer cell 104, a battery cell bank 106, a water tank 108, and a DC circuit 110. The electrolyzer system 100 converts water into hydrogen and oxygen gas through electrolysis, producing hydrogen-hydrogen-oxygen (“HHO”) gas for cooking and heating purposes. In the illustrated embodiment, the electrical energy source 102 is a solar panel that captures sunlight and converts solar energy into electrical energy. The battery cell bank 106 stores electrical energy received from the electrical energy source 102. The DC circuit 110 connects the battery cell bank 106 to the electrolyzer cell 104 and delivers direct current (“DC”) to the electrolyzer cell 104. In some embodiments, the DC current is kept constant. In some embodiments, the DC current fluctuates (e.g., pulses) periodically. The DC current may be controlled by adjusting the voltage supplied by the electrical energy source 102, or regulated by an electrical conductor. The water tank 108 supplies water to the electrolyzer cell 104 for the electrolysis process. The water may be ocean water, salt water, ionized water, alkaline water, purified water, mineral water, and/or distilled water.

In some embodiments, the electrolyzer cell 104 comprises an electrical conductor, a tube, and a rod. The electrolyzer cell 104 receives electrical power from the DC circuit 110 and water from the water tank 108. The electrolyzer cell 104 uses electrolysis methods to disassociate water into hydrogen gas and oxygen gas. The tube and rod within the electrolyzer cell 104 function as electrodes that facilitate the electrolysis reaction when DC current flows through the electrical conductor. The electrolyzer system 100 enables green energy fuel production by combining solar power with water to generate hydrogen and oxygen gas with net zero carbon content after burning.

With continued reference to FIG. 1, in some embodiments, the power source comprises the electrical energy source 102 without the battery cell bank 106. The electrical energy source 102 provides direct electrical power to the electrolyzer cell 104 through the DC circuit 110. This configuration reduces system complexity and cost by eliminating energy storage components. In some embodiments, the electrical energy source 102 comprises one or more of a wind turbine, a solar panel, a hydroelectric generator, or a grid-connected power supply. In some embodiments, the electrolyzer system 100 operates with any DC power source capable of supplying sufficient current to the electrolyzer cell 104.

In some embodiments, the power source comprises the battery cell bank 106 without the electrical energy source 102. The battery cell bank 106 provides stored electrical energy to the electrolyzer cell 104 through the DC circuit 110. This configuration enables fuel generation even when energy generation is not available, such as during nighttime hours for solar panels, or times without wind for wind turbines. In some embodiments, the battery cell bank 106 comprises standard automobile batteries, which are commonly available and provide sufficient power for heating fuel generation during emergency situations. In some embodiments, the battery cell bank 106 comprises custom-designed batteries, portable power banks, marine batteries, or deep-cycle batteries. In some embodiments, the electrolyzer system 100 operates with any battery source capable of delivering DC power to the electrolyzer cell 104.

In some embodiments, the water source comprises salt water from the water tank 108. Ocean water provides a readily available water source for individuals in coastal or island locations. The electrolyzer cell 104 processes salt water to produce hydrogen and oxygen gas through electrolysis. In some embodiments, the water source comprises fresh water, distilled water, or other water types suitable for electrolysis. In some embodiments, the water tank 108 stores water and delivers water to the electrolyzer cell 104 at a controlled rate to maintain consistent gas production. The water tank 108 may be separately housed from the electrolyzer system 100, or it may be integrated into a single body. In some embodiments, the water tank 108 is a naturally formed water source, such as a lake, a river, an ocean, or a pond.

In some embodiments, the electrolyzer system 100 is configured for use in space environments for spacecraft missions. The electrolyzer system 100 produces hydrogen and oxygen gas from electrical power generated by sunlight using solar panels and water carried aboard the spacecraft. The compact and modular design of the electrolyzer system 100 enables deployment in spacecraft where volume and weight constraints limit equipment options. The electrolyzer system 100 supports extended mission durations by generating fuel from renewable solar energy and stored water resources. In some aspects of the present technology, the fuel generation system enables self-sufficient fuel production in remote terrestrial locations and extraterrestrial environments where traditional fuel supply chains do not exist.

### Fuel Generator

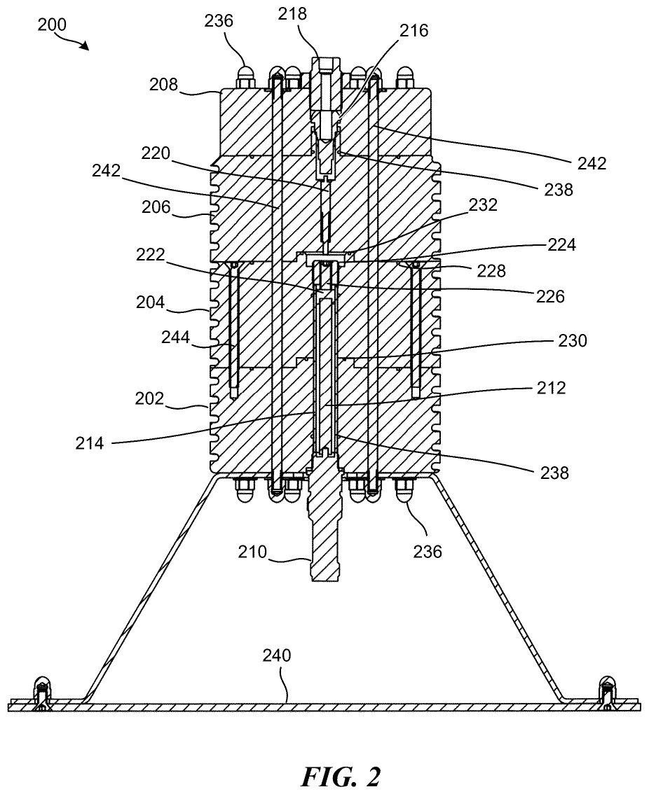

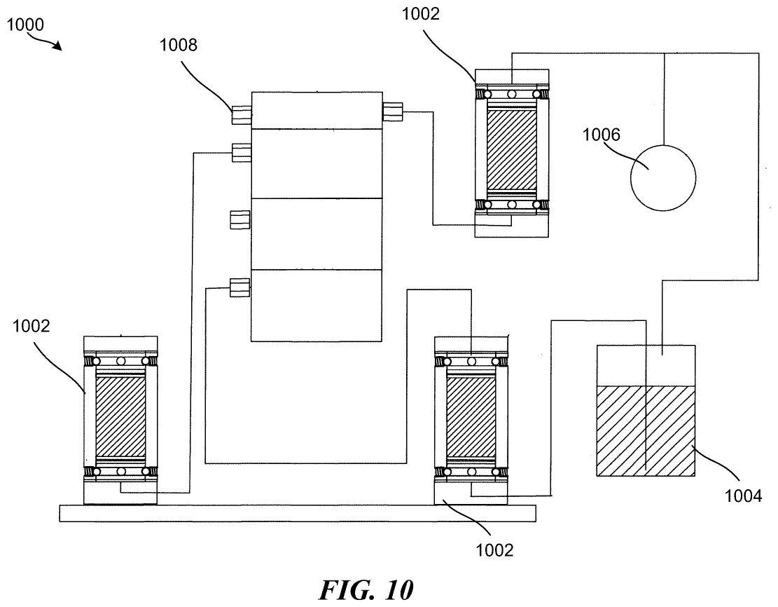

In some embodiments, such as illustrated in FIG. 2, a fuel generation system 200 comprises a body formed from four disk plates stacked vertically, including plate one 202 at the bottom, plate two 204 positioned above plate one 202, plate three 206 positioned above plate two 204, and plate four 208 at the top. In the illustrated embodiment, the fuel generation system 200 includes an electrical conductor 210 positioned at the bottom of plate one 202, a hollow tube 214 extending through the interior of plate one 202 and plate two 204, and a rod 212 centrally positioned within the hollow tube 214. The fuel generation system 200 further includes an assembly valve 216 secured at the top of plate four 208, a bushing 218 that holds the assembly valve 216 in position, a pin 220 housed within plate three 206, and a non-conductive sleeve 222 that maintains the central positioning of the rod 212 within the hollow tube 214. In some aspects of the present technology, the fuel generation system 200 enables on-demand generation of hydrogen and oxygen gas through electrolysis for heating and cooking purposes. In some embodiments, such as described in FIG. 10 below, the hydrogen and oxygen are separated after generation. In other embodiments, the hydrogen and oxygen gas are stored together in at least one chamber.

With continued reference to FIG. 2, in the illustrated embodiment, the body of the fuel generation system 200 is machined from one solid rod of aluminum. In other embodiments, the fuel generation system is machined from brass, copper, platinum, noncorrosive steel, tin, and/or titanium. In some embodiments, the body is machined from a six-inch diameter by 10.75-inch long solid aluminum rod divided into four plates, where plate one 202, plate two 204, and plate three 206 are each three inches long, and plate four 208 is 1.750 inches long. Some embodiments of the fuel generation system 200 has overall dimensions of approximately sixteen inches by sixteen inches. The components of the fuel generation system 200 may be constructed from materials selected for heat resistance, corrosion resistance, electrical conductivity, and/or structural durability.

In some embodiments, the exterior surfaces of plate one 202, plate two 204, plate three 206 and/or plate four 208 feature grooves 224 that form a threaded pattern around the outer circumference of the body. The grooves 224 may have a thread design of 0.1875 inches wide by 0.220 inches deep with a bottom trough that is hemispherical. The hemispherical bottom trough retains an external cooling means for the electrolysis cell within the housings. In some embodiments, the grooves 224 are configured to house piping. A cooling fluid may flow through the piping to dissipate heat during the electrolysis process. In some embodiments, the grooves 224 extend from the lower end of plate one 202 upward in one continuous thread to the top end of plate three 206.

In some embodiments, plate one 202, plate two 204, plate three 206, and/or plate four 208 comprise wiring. The wiring may begin at the base of plate one and travel in a spiral pattern to the top of plate three. In some embodiments, the wiring is wound around the fuel generation system 200 to begin at plate one 202, spiral up to plate three 206, and spiral back down to plate one 202. In some embodiments, the wiring is housed in the grooves 224. The wiring may be copper wiring, silver wiring, aluminum wiring, gold wiring, and/or any other materials known to conduct electricity. In some embodiments, the wiring is configured to dissipate heat from the fuel generation system 200 during electrolysis. In some embodiments, the wiring forms a single unified strand when the plates are assembled. In some embodiments, the wiring is separated between one or more of the plates. In some embodiments, each section of the wiring is configured to wrap up and down its respective plate. In some embodiments, current is passed through the wiring to create at least one induction coil. The wiring may form a cascading electromagnetic array.

In some embodiments, the induction coil created by running current through the wiring is configured to produce at least one electromagnet acting on water. In some embodiments, the fuel generation system 200 is configured to produce drinking water and/or purified air. In some embodiments, the at least one electromagnet acting on the water improves the hydration properties when consumed. The purified air may be generated by mixing HHO gas produced during electrolysis with air. The HHO gas may be mixed with air at a ratio of 2% hydrogen to air. The application of at least one electromagnet on the water may enable the formation of structured water suitable for drinking, while also continuing to enable the production of hydrogen gas and oxygen gas through electrolysis. Structured water may improve sleep, increase energy, promote weight loss, and/or support a healthy immune system when consumed. In some embodiments, the fuel generation system 200 comprises at least one filtration system (e.g., the filtration system 1002 of FIG. 10). The filter may filter water and/or gas as it enters the fuel generation system 200 and/or as water and/or gas exits the fuel generation system 200. The filter may be a carbon inlet filter and/or a carbon outlet filter. In some embodiments, the filter is configured to be rotated 360 degrees to a specific degree angle that can be altered for easy assembly and disassembly with the fuel generation system 200. The filter may prevent outside elements from contacting with rotatable end plugs. In some embodiments, the filter is configured to allow a user to service and/or replace the filter without unthreading or replacing the filter container. In some embodiments, the fuel generation system 200 comprises a filter with a fitting that is centrally aligned with the longitudinal axis of a tube container. The fuel generation system 200 may comprise an ultra-violet lighting system configured to kill bacteria, viruses, and/or mold in water taken into the fuel generation system 200.

As further shown in the illustrated embodiment of FIG. 2, all four plates comprise two polar arrays of apertures for assembly purposes. Some embodiments include an outer array includes eight apertures having a circumference centerline of 4.5 inches, and an inner array includes four apertures having a circumference centerline of 2.25 inches. Connection rods 242 extend through the polar arrays of all four plates and are secured at each end by threaded fastener nuts 236. In some embodiments, the connection rods 242 comprise twelve solid rods that are 0.25 inches in diameter and 10.675 inches long, threaded on each end. In some embodiments, the fuel generation system 200 uses twenty-eight stainless steel 0.250-inch by 20 acorn nuts and hard washer seals for assembly. The connection rods 242 and threaded fastener nuts 236 may bind the four disk plates together to form the unified body of the fuel generation system 200. In some embodiments, the connection rods 242 and threaded fastener nuts 236 are configured to be tightened and loosened repeatedly, enabling users to assemble and disassemble the fuel generation system 200 for maintenance, storage, and transport.

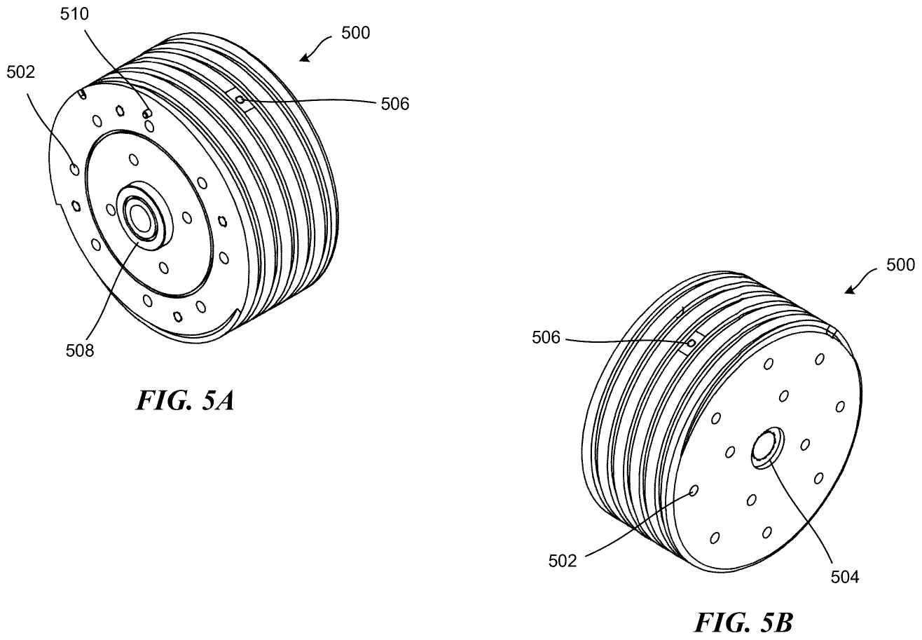

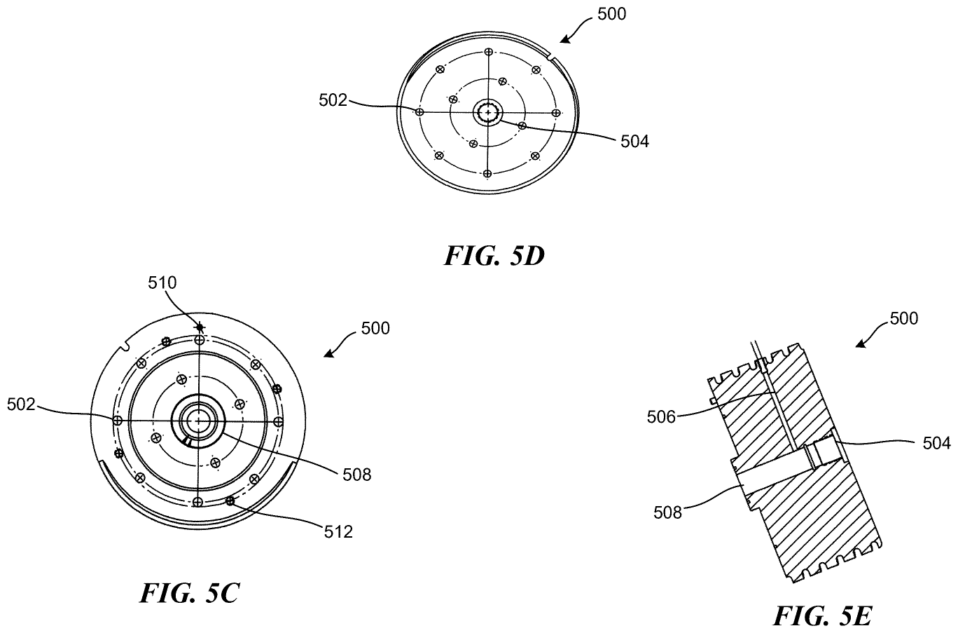

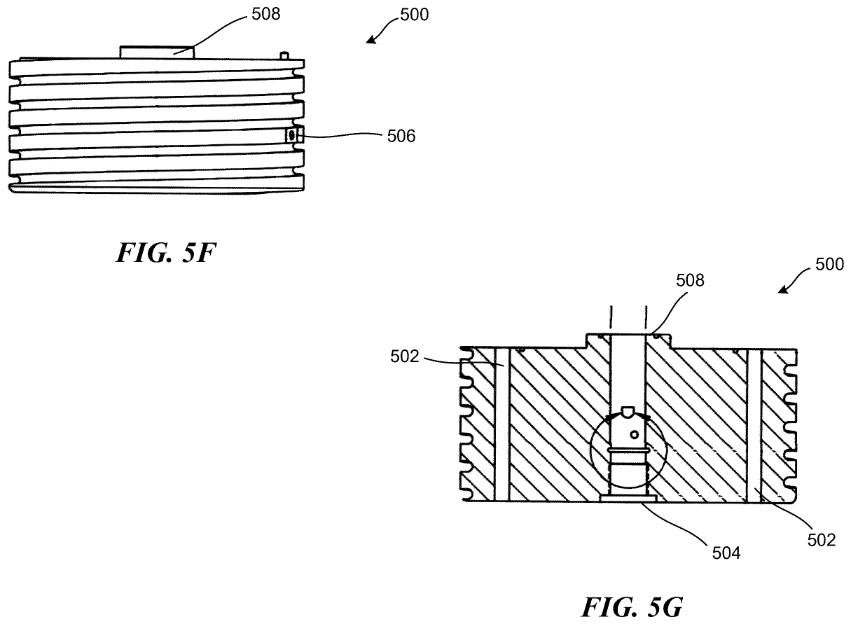

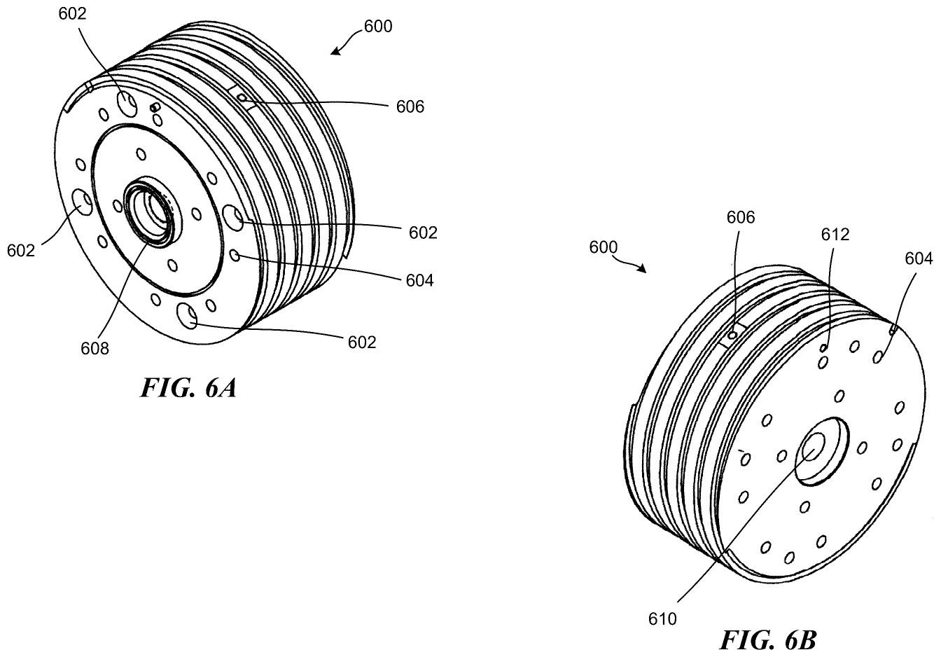

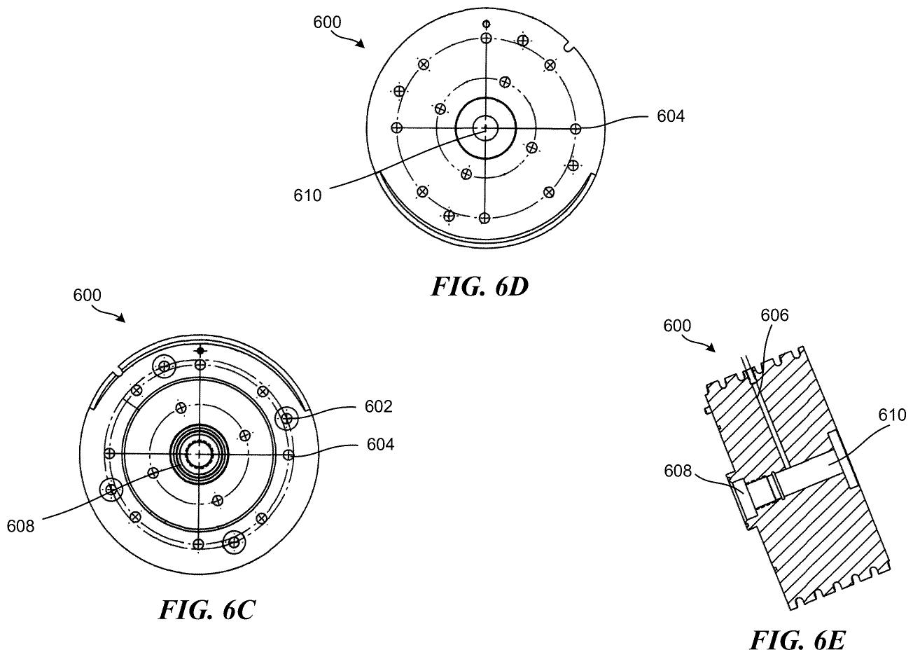

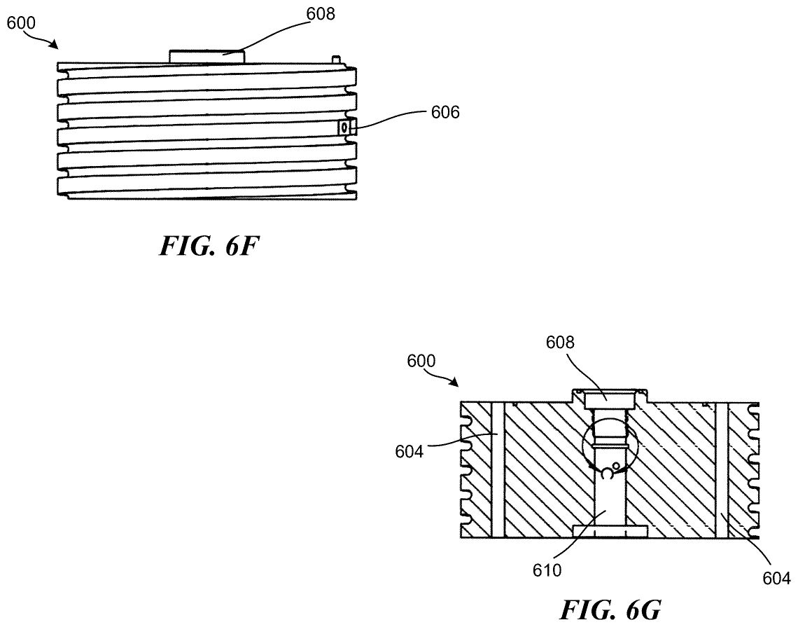

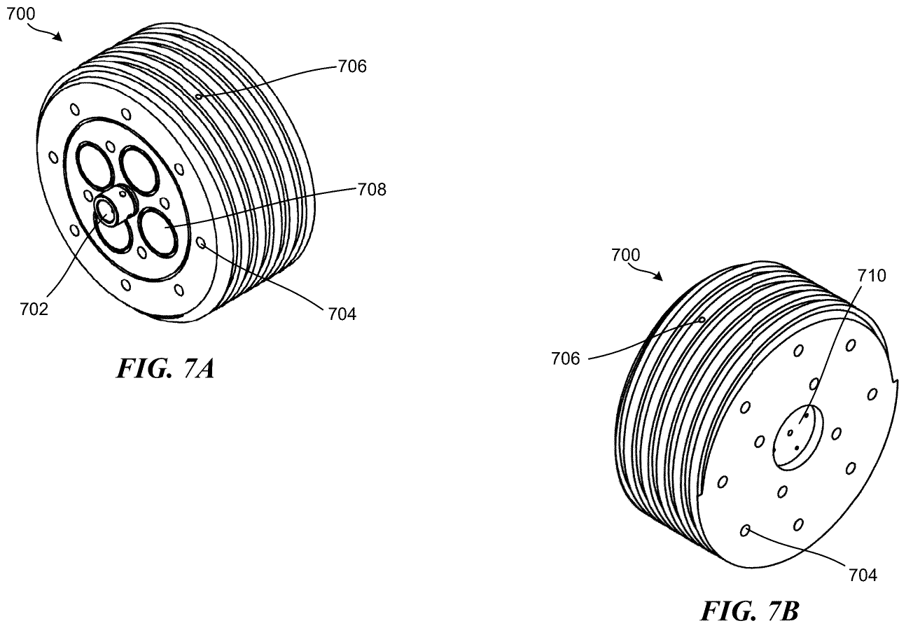

In some embodiments, plate one 202, plate two 204, plate three 206, and/or plate four 208 comprise an index pin (such as the index pin 510 described in FIG. 5). The index pin may be configured to fit into an index hole (such as the index hole 612 described in FIG. 6) of an adjacent plate. This connection allows the plates to be properly aligned with each other during assembly so that the internal components are oriented correctly. In some embodiments, only plate one 202 and plate two 204 are connected using an index pin and an index hole. In some embodiments, each plate is connected to the adjacent plates by an index hole and/or an index pin.

In some embodiments, plate one 202 and plate two 204 are configured to be torqued together during assembly. By torquing plate one 202 and plate two 204 together, the system may be assembled to establish the conductor contacts without damaging the electrical conductor 210, the rod 212, and/or the hollow tube 214. In some embodiments, plate one 202 and plate two 204 are connected using at least one electrolyzer assembly rod 244. The electrolyzer assembly rod 244 may be configured to allow plate one 202 and plate two 204 to be torqued together during assembly. In some embodiments, there are four electrolyzer assembly rods 244. Each electolyzer assembly rod 244 may have a diameter of about 0.2 inches. In some embodiments, plate one 202 and plate two 204 are torqued together without the use of an electolyzer assembly rod 244.

In some embodiments, the fuel generation system 200 includes a bore 226 within plate three 206 that houses the pin 220. The pin 220 responds to gas pressure buildup within the fuel generation system 200 and moves upward to actuate the assembly valve 216 for controlled gas release. In some embodiments, an outer groove 228 and an inner groove 230 are configured to retain O-rings 238 that prevent liquid from escaping between the assembled plates. In some embodiments, at least one outlet port 232 is positioned within plate three 206 and distributes produced gas away from the hollow tube 214 and rod 212. In some embodiments, a base 240 is mounted to the bottom of plate one 202 and provides structural support for the fuel generation system 200. The base 240 may comprise supports configured to allow the fuel generation system 200 to stand upright without additional support.

With continued reference to FIG. 2, the electrical conductor 210 may be a modified Champion RHM38E aviation spark plug. The electrical conductor 210 allows for an electrical connection to the rod 212 and the hollow tube 214. In some embodiments, the rod 212 is configured as a cathode and the hollow tube 214 is configured as an anode in an electrical circuit. The electrical conductor 210 may be sealed to withstand high gas compression to the outside environment. In some embodiments, the non-conductive sleeve 222 is positioned between the hollow tube 214 and the rod 212 and maintains electrical isolation between the two conductors while centrally positioning the rod 212 within the hollow tube 214. In some aspects of the present technology, the fuel generation system 200 enables electrolysis when current is passed through the electrical conductor 210 to the rod 212 and the hollow tube 214 while water fills the space between the rod 212 and the hollow tube 214.

In some embodiments, the fuel generation system 200 is scaled up or down in size to meet varying gas production requirements. In some embodiments, scaling is achieved by adding or subtracting thickness to plate one 202, plate two 204, plate three 206, and plate four 208. Increased plate thickness allows for longer hollow tubes 214 and rods 212 within the electrolysis cell, providing greater electrode surface area and increased gas production capacity. In some embodiments, scaling is achieved by increasing or decreasing the diameter of plate one 202, plate two 204, plate three 206, and plate four 208. Larger diameter plates provide additional internal volume to, in some cases, accommodate multiple tube and rod assemblies arranged in parallel within the electrolysis cell.

In some embodiments, the fuel generation system 200 includes two, three, four, or more hollow tubes 214 and corresponding rods 212 positioned within bores of the plates. In some embodiments, scaling combines increased plate thickness with increased plate diameter to maximize gas production capacity. In some embodiments, the hollow tube 214 and rod 212 are scaled to larger diameters to increase electrode surface area within a single tube and rod assembly. In some embodiments, the hollow tube 214 has an outer diameter ranging from 0.5 inches to 2.0 inches, and the rod 212 has a diameter ranging from 0.125 inches to 1.0 inch, depending on the desired gas production capacity. Larger diameter tubes and rods provide increased surface area for the electrolysis reaction, resulting in higher rates of hydrogen and oxygen gas production. In some embodiments, the chambers 318 within plate three 206 are correspondingly enlarged or increased in number to accommodate the increased gas output from scaled electrolysis cells.

In some embodiments, the fuel generation system 200 is scaled down in size. Reduced plate thickness and diameter result in a more compact and lightweight fuel generator that users may transport more readily between locations. Smaller scale embodiments may be configured for single-person operation, allowing individuals to carry, set up, and disassemble the fuel generation system 200 without assistance. In some cases, the reduced component sizes facilitate storage in confined spaces such as vehicle compartments, closets, or emergency supply kits. The decreased scale may also simplify the disassembly process by reducing the weight of individual plates and shortening the length of connection rods 242, enabling users to perform maintenance and cleaning tasks with greater ease.

In some embodiments, a carbon rod or carbon tube is placed over the rod 212 and within the hollow tube 214. The carbon rod or carbon tube may increase conductivity between the electrodes, resulting in increased electrolysis and fuel production. Gas production may be increased or decreased by regulating the voltage applied to the electrical conductor 210. Higher voltage levels increase the rate of electrolysis and gas production, while lower voltage levels decrease gas production. In some embodiments, the carbon rod or carbon tube is configured as a sleeve that fits over the outer surface of the rod 212, providing an enhanced conductive layer while maintaining the structural support of the underlying rod 212. In some embodiments, the carbon rod or tube is integrated with the rod 212. In some embodiments, the carbon rod replaces the rod 212 entirely, with the carbon material serving as an electrode within the hollow tube 214.

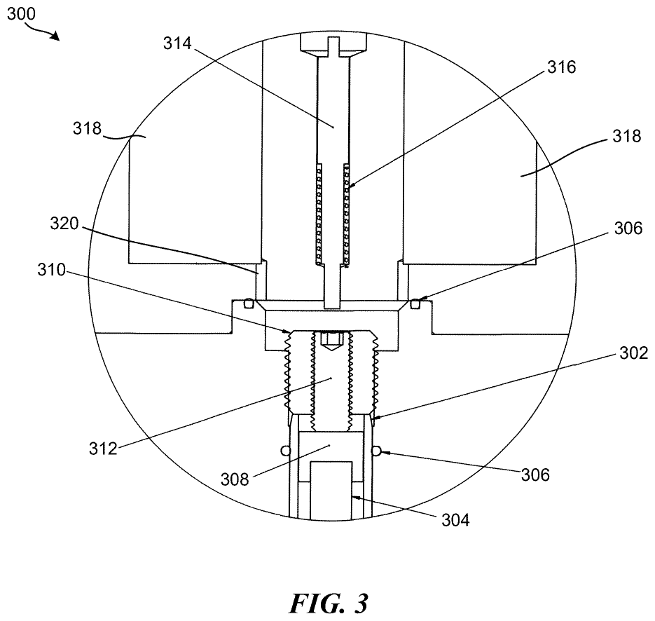

In some embodiments, such as illustrated in FIG. 3, a gas transfer system 300 comprises a hollow tube 302, a rod 304, O-rings 306, a pin 314, a spring 316, and chambers 318. Hydrogen and oxygen gas produced during electrolysis may be transferred from the electrolyzer cell into the chambers 318 for pressure regulation and distribution. In the illustrated embodiment, the hollow tube 302 is positioned vertically at the center of the assembly, with the rod 304 centrally located within the hollow tube 302. A non-conductive sleeve 308 may be positioned between the hollow tube 302 and the rod 304, maintaining the central positioning of the rod 304 within the hollow tube 302 while preventing electrical contact between the two components. In some aspects of the present technology, the gas transfer system 300 enables controlled transfer of generated gas from the electrolysis cell to at least one chamber 318 operatively connected to the electrolyzer cell and configured to store hydrogen and oxygen gas received from the electrolyzer cell.

With continued reference to FIG. 3, a bushing 310 may interface with a bore 312 machined into the fuel generator to secure and position the hollow tube 302 within the assembly. In some embodiments, the bore 312 receives the hollow tube 302 and provides structural support for the electrolysis cell components. O-rings 306 may be positioned at multiple locations throughout the gas transfer system 300 to provide sealing between components and prevent fluid leakage. In some embodiments, the O-rings 306 seal the connection points between the hollow tube 302 and the bore 312, preventing fluid from leaking from the space created between the hollow tube 302 and the rod 304 into the bore 312. In some embodiments, the O-rings 306 seal outlet ports 320 so that generated gas passes through into the chambers 318 without excess fluid.

In some embodiments, a chamber 318 is positioned on each side of the central assembly and each chamber 318 is configured to retain liquid and receive generated gas fuel from the electrolysis process occurring within the hollow tube 302 and rod 304 arrangement. In the illustrated embodiment, the chambers 318 comprise four hollow chambers bored in a radial polar array that retain liquid and function as bubble chambers for anti-blowback. Generated gas is transported from the hollow tube 302 and rod 304 system through outlet ports 320 that connect to the chambers 318. In some embodiments, the gas passes through liquid retained in the chambers 318, creating bubbles that rise through the liquid before collecting in the upper portion of the chambers 318. In some aspects of the present technology, the bubble chamber configuration prevents backflow of gas into the electrolysis cell during pressure fluctuations.

As further shown in FIG. 3, the pin 314 may extend vertically in the upper portion of the gas transfer system 300 and comprise the spring 316. In some embodiments, the pin 314 has dimensions of 0.236 inches in diameter by 2.040 inches in length and is machined on each end with a 0.085-inch diameter top end and a 0.120-inch diameter bottom end. In some embodiments, the spring 316 is operatively connected to the pin 314 and provides a biasing force on the pin 314 to regulate gas pressure within the system. In some embodiments, the spring 316 is configured to interact with a valve to release gas under pressure when gas pressure buildup acts on the bottom end surface of the pin 314 and spring 316. The upward movement of the pin 314 may actuate the valve mechanism for controlled gas release.

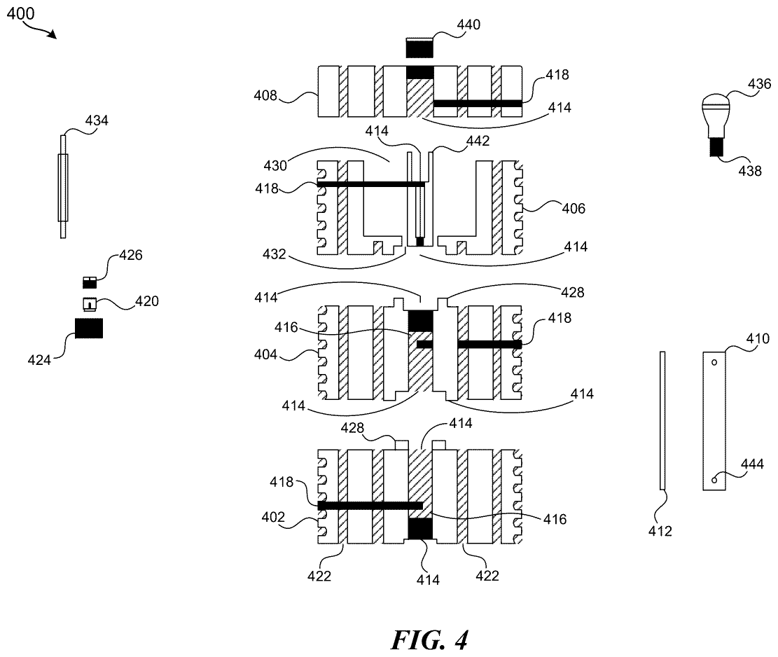

In some embodiments, the pin 314 is a pressure differential pin and, in conjunction with a pressure differential valve, is configured to evenly distribute pressure created by the gas between the chambers 318. When gas pressure reaches a predetermined threshold, the pin 314 moves upward against the biasing force of the spring 316 and engages the valve stem of an assembly valve (for example, the assembly valve 436 described in FIG. 4). In some embodiments, the pin 314 has a large end diameter of 0.120 inches and a small end diameter of 0.085 inches. As gas and/or water pressure acts on the large end, the pin 314 is pushed upward such that the small end pushes on the valve opening stem. Th spring 316 may bias the resistance of the valve to open to create an outward distribution of gas. In some embodiments, the assembly valve is configured to close when a backpressure is present at an outlet orifice (e.g., the bushing 440 described in FIG. 4). In some embodiments, the assembly valve is a TR413 tire valve positioned into a bore and firmly held stationary by a valve tensioner adapter. In some embodiments, the pressure differential valve releases accumulated gas at a controlled rate, maintaining consistent pressure across the chambers 318 and enabling even gas distribution for subsequent use.

FIG. 4 illustrates a cross-section of a separated fuel generation system 400 comprising plate one 402 at the bottom, plate two 404 positioned above plate one 402, plate three 406 positioned above plate two 404, and plate four 408 at the top. In some embodiments, plate one 402 comprises a bore 414 configured to contain a hollow tube 410 and a rod 412. In some embodiments, the bore 414 retains an electrical conductor (such as the electrical conductor 210 described in FIG. 2). An outer rim 426 of the electrical conductor interfaces with the hollow tube 410 to provide electrical connection, while securing the rod 412 against the center conductor of the electrical conductor. In some embodiments, a port 418 extends from the outer circumference of plate one 402 to the bore 414 and provides a pathway for water to enter the electrolyzer chamber. Assembly holes 422 may be arranged in polar arrays through plate one 402 and accommodate connection rods that secure the plates together during assembly.

In some embodiments, plate two 404 includes a bore 414 aligned with a boss 428 of plate one 402 to securely connect plate one 402 and plate two 404. An O-ring 416 may be positioned within grooves around the bore 414 to seal the assembly and prevent liquid from entering between the bore 414 and the outer circumference of the hollow tube 410. In some embodiments, the O-ring 416 is positioned in grooves at the face surface of the boss 428 to seal the electrolysis cell liquid. In some embodiments, a boss 428 protrudes from the top face of plate two 404 and aligns into a bore 414 of plate three 406. In some embodiments, the boss 428 on the top side of each plate is 0.250 inches thick and fits into the bore 414 on the underside of the adjacent plate for alignment and sealing.

In the illustrated embodiment of FIG. 4, plate three 406 includes chambers 430 arranged in a radial polar array and configured to retain hydrogen and oxygen gas. Gas holes 432 connect the chambers 430 to the bore 414 housing the hollow tube 410 and rod 412, allowing passage of generated gas fuel into the chambers 430. In some embodiments, a pin 434 is positioned within bore 414 of plate three 406 and responds to gas pressure buildup. A post 442 may protrude from the top face of plate three 406 and align into plate four 408.

In some embodiments, plate four 408 includes a valve 436 with a valve stem 438 that is acted upon by the upward movement of the pin 434 to release gas under pressure. In some embodiments, plate four 408 provides a compressed gas and gas mixing manifold function. In some embodiments, bushing 440 secures the valve 436 in position within plate four 408. In some aspects of the present technology, the fuel generation system enables controlled release of hydrogen and oxygen gas through the valve 436 for heating and cooking applications.

In some embodiments, the fuel generator is configured to be assembled and disassembled by users without specialized tools. The assembly process comprises inserting the hollow tube 410 and rod 412 into the bore 414 of plate one 402 and plate two 404, and securing an electrical conductor into a threaded bore 414 of plate one 402. Port connections 444 on the hollow tube 410 are aligned with ports 418 in plate one 402 and plate two 404 to allow water to flow into the electolyzer cell. The plates are stacked in sequence with the boss 428 of each plate fitting into the corresponding bore of the adjacent plate. Connection rods are inserted through the assembly holes 422 and secured with threaded fastener nuts to bind the four disk plates together. In some embodiments, the electrical conductor is a spark plug that provides electrical connection to the rod 412 and the hollow tube 410 for the electrolysis process.

In some embodiments, the bushing 440 is threaded into a bore having M18×1.5 thread pitch and rotated clockwise until resistance indicates that conductor tube ends are binding the hollow tube 410 to the rim face of the spark plug and the rim face of the bushing 440. A stainless steel flat tip set screw having 5/16-inch by 24 threads is threadably inserted into the center bore of the bushing 440 and rotated clockwise until resistance is achieved binding the flat end of the set screw onto the flat end of a rod isolator. In some embodiments, a non-conductive sleeve 420 is positioned between the hollow tube 410 and the rod 412 and centrally positions the rod 412 within the hollow tube 410 while maintaining electrical isolation between the two conductors. In some embodiments, screws are radially positioned around the hollow tube 410 and torqued to bind plate two 404 to plate one 402.

In some embodiments, such as illustrated in FIGS. 5A-5G, plate one 500 comprises assembly holes 502, a bore 504, a port 506, and a boss 508. Plate one 500 forms the bottom portion of the fuel generator assembly and houses the lower half of the anode and cathode components of the electrolysis cell. In the illustrated embodiment, plate one 500 is cylindrical in shape. In some embodiments, plate one 500 is cubic, octagonal, hexagonal, and/or another polygonal shape suitable for the fuel generator assembly. The components of plate one 500 may be constructed from materials selected for heat resistance, heat dissipation, compatibility with elements used in electrolysis processes, and structural integrity while internally pressurized from heating fuel production.

In some embodiments, plate one 500 comprises an index pin 510 configured to connect with an index hole of plate two (for example, the index hole 612 described in FIG. 6). The index pin 510, when connected to a corresponding index hole, ensures that plate one 500 is properly aligned with plate two. The index pin 510 may be round, cylindrical, square, triangular, and/or octagonal. In some embodiments, there is a single index pin 510. In some embodiments, there are multiple index pins. In embodiments with more than one index pin 510, the index pins 510 may be identical or they may each be uniquely shaped and/or sized to ensure that plate one 500 is properly aligned with plate two. In some embodiments, the index pin 510 is configured to allow plate one 500 and plate two to be torqued together during assembly to ensure that the conductor contacts are properly connected without damaging the electolyzer system. In some embodiments, plate one 500 is configured to connect with plate two using a torque connection 512. The torque connection 512 may comprise a torque connection 512 hole configured to hold an electrolyzer assembly rod (such as the electolyzer assembly rod 244 described in FIG. 2). In some embodiments, the toque connection 512 is configured to connect plate one 500 and plate two without the use of an electrolyzer assembly rod.

With continued reference to FIGS. 5A-5G, the bore 504 may be positioned at the center of plate one 500 and configured to receive a hollow tube and a rod used for electrolysis. In some embodiments, the bore 504 is sized to slip fit the lower half of the hollow tube and connect with the outer conductor of an electrical conductor retained in a threaded bore. In some embodiments, the bore 504 has a diameter of approximately 0.625 inches to accommodate the hollow tube. In some embodiments, the bore 504 has a diameter ranging from 0.5 inches to 1.0 inch to connect with different hollow tube and rod configurations. The bore 504 extends through plate one 500 to allow the hollow tube and rod to span from plate one 500 into an adjacent plate during assembly.

In some embodiments, the port 506 extends from the outer circumference of plate one 500 inward and terminates at the bore 504. The port 506 provides a pathway for water to enter the electrolyzer chamber during operation. In some embodiments, the port 506 is drilled at a position that aligns with a connection slot on the hollow tube. The slot on the hollow tube matches up to the port 506 of plate one 500 to allow water to enter and exit the electrolyzer chamber. In some embodiments, plate one 500 includes a single port 506. In some embodiments, plate one 500 includes two or more ports 506 arranged around the outer circumference to provide multiple fluid access points to the bore 504.

As further shown in FIGS. 5A-5G, the boss 508 may protrude from the top face of plate one 500 and align with a corresponding bore in an adjacent plate during assembly. In some embodiments, the boss 508 is 0.250 inches thick and fits into a bore on the underside of the adjacent plate for alignment and sealing. In some embodiments, the boss 508 has a thickness ranging from 0.125 inches to 0.375 inches depending on the sealing and alignment requirements of the fuel generator configuration. The boss 508 provides precise positioning between plates and enables proper sealing of the electrolysis cell liquid.

In some embodiments, the assembly holes 502 are arranged in polar arrays through plate one 500. In the illustrated embodiment, the assembly holes 502 comprise an outer array of twelve apertures and an inner array of four apertures. In some embodiments, the assembly holes 502 comprise six apertures in the outer array and three apertures in the inner array. In some embodiments, the assembly holes 502 comprise ten or more apertures in the outer array and six or more apertures in the inner array for larger fuel generator configurations. The assembly holes 502 accommodate connection rods that pass through all four plates and are secured with threaded fastener nuts to bind the disk plates together.

In some embodiments, plate one 500 includes groove patterns configured to retain O-ring seals. An outer groove retains an O-ring seal around the boss 508 to prevent liquid from escaping between plate one 500 and the adjacent plate. An inner groove retains an O-ring seal around the bore 504 to prevent liquid from entering between the bore 504 and the outer circumference of the hollow tube. In some embodiments, the grooves have a depth of approximately 0.0625 inches to accommodate standard O-ring dimensions. The O-ring seals provide fluid-tight connections that maintain the integrity of the electrolysis cell during operation.

In some embodiments, such as illustrated in FIGS. 6A-6G, plate two 600 comprises assembly holes 604, a port 606, a boss 608, and a bore 610. In some embodiments, plate two 600 forms the upper portion of the electrolyzer cell and houses the upper half of the anode and cathode components. In the illustrated embodiment, plate two 600 is cylindrical in shape and functions as a mirror component to the plate one 500. In some embodiments, plate two 600 is cubic, octagonal, hexagonal, and/or another polygonal shape suitable for the fuel generator assembly.

In some embodiments, plate two 600 comprises an index hole 612 configured to connect with an index pin of plate one (for example, the index pin 510 described in FIG. 5). The index hole 612, when connected to a corresponding index pin, ensures that plate two 600 is properly aligned with plate one and/or plate three. The index hole 612 may be round, cylindrical, square, triangular, and/or octagonal. In some embodiments, there is a single index hole 612. In some embodiments, there are multiple index holes 612. In embodiments with mor than one index hole 612, the index holes 612 may be identical or they may each be uniquely shaped and/or sized to ensure that plate two 600 is properly aligned with plate one and/or plate three. In some embodiments, the index hole 612 is configured to allow plate two 600 and plate one to be torqued together during assembly to ensure that the conductor contacts are properly connected without damaging the electrolyzer system. In some embodiments, plate two 600 further comprises an index pin similar to the index pin 510 described in FIG. 5 and configured to connect with a corresponding index hole of plate three. In some embodiments, plate two 600 comprises at least one additional index hole 612 configured to connect with a corresponding index pin on plate three to ensure that the two plates are aligned correctly during assembly.

With continued reference to FIGS. 6A-6G, the bore 610 may be positioned centrally within plate two 600 and configured to receive the upper portion of a hollow tube and rod used in the electrolysis process. In some embodiments, the bore 610 has a diameter of approximately 0.625 inches to accommodate the hollow tube. In some embodiments, the bore 610 has a diameter ranging from 0.5 inches to 1.0 inch to connect with different electrolysis configurations. In some embodiments, the bore 610 aligns with the boss plate one 500 to form a continuous chamber that houses the hollow tube and rod. In some embodiments, the hollow tube has a wall thickness that is calculated and adjusted to maximize gas production efficiency by adding wall thickness to increase conductivity. In some embodiments, the hollow tube has a chamfered end with dimensions of 0.1 inches in length by 10 degrees for assembly purposes into O-ring groove bores in plate two 600.

In some embodiments, the boss 608 protrudes from the top face of plate two 600 and aligns with a corresponding bore in an adjacent plate during assembly. In some embodiments, the boss 608 is 0.250 inches thick. In some embodiments, the boss 608 has a thickness ranging from 0.125 inches to 0.375 inches depending on the sealing and alignment requirements. The boss 608 may provide precise positioning between plate two 600 and plate three while enabling proper sealing of the electrolysis cell liquid.

As further shown in FIGS. 6A-6G, a port 606 may extend from the outer circumference of plate two 600 inward and terminate at the bore 610. The port 606 provides a pathway for water to enter and exit the electrolyzer chamber during operation. In some embodiments, the port 606 aligns with a connection slot on the hollow tube to allow water flow into the electrolysis cell. In some embodiments, plate two 600 includes a single port 606. In some embodiments, plate two 600 includes two or more ports 606 arranged around the outer circumference to provide multiple fluid access points.

In some embodiments, the assembly holes 604 are arranged in polar arrays through plate two 600. In the illustrated embodiment, the assembly holes 604 comprise an outer array of twelve apertures and an inner array of four apertures. In some embodiments, the assembly holes 604 comprise six apertures in the outer array and three apertures in the inner array. In some embodiments, the assembly holes 604 accommodate connection rods that pass through all four plates and are secured with threaded fastener nuts. In some embodiments, a portion of the assembly holes 604 are configured to contain connection rods configured to only link plate one and plate two 600. In some embodiments, plate two 600 includes groove patterns configured to retain O-ring seals around the boss 608 and the bore 610. the O-ring seals provide fluid-tight connections that maintain the integrity of the electrolysis cell during operation.

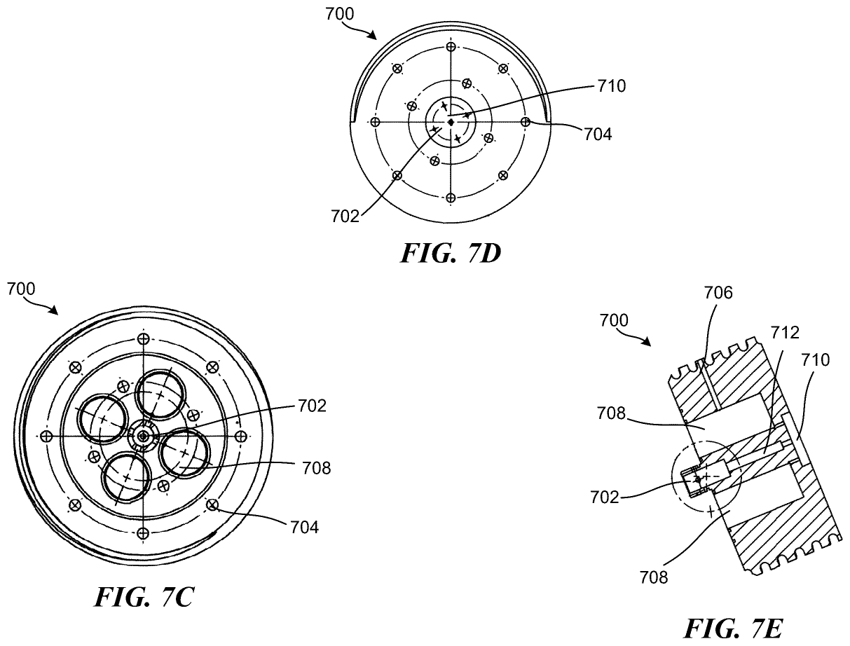

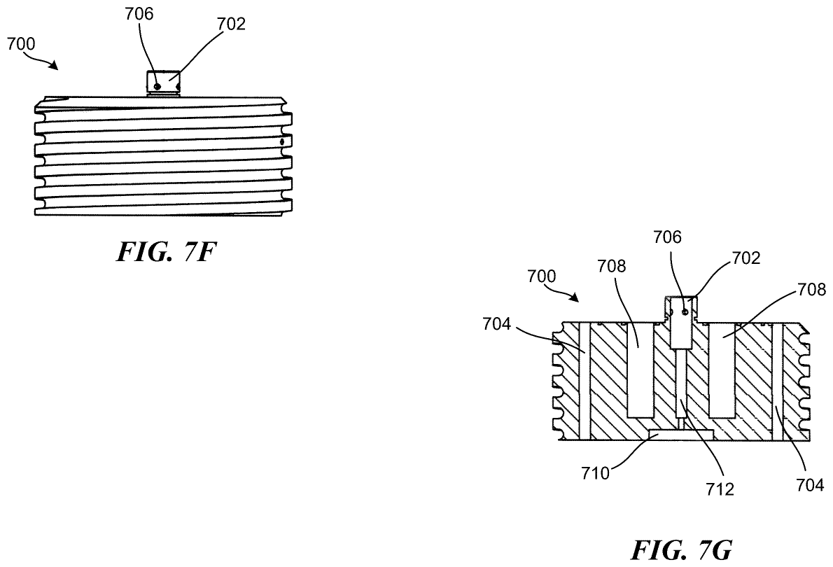

In some embodiments, such as illustrated in FIGS. 7A-7G, plate three 700 comprises a boss 702, assembly holes 704, a port 706, a chamber 708, a bore 710, and a pin bore 712. Plate three 700 may form the bubbler chamber housing of the fuel generator assembly and provides anti-blowback capabilities during gas transfer operations. In the illustrated embodiment, plate three 700 is cylindrical in shape. In some embodiments, plate three 700 is cubic, octagonal, hexagonal, and/or another polygonal shape suitable for the fuel generator assembly. The components of plate three 700 may be constructed from materials selected for heat resistance, corrosion resistance, and structural integrity while internally pressurized from heating fuel production.

With continued reference to FIGS. 7A-7G, the bore 710 may be positioned centrally within plate three 700 and configured to receive components from adjacent plates during assembly. In some embodiments, the bore 710 has a diameter of approximately 0.625 inches. In some embodiments, the bore 710 has a diameter ranging from 0.5 inches to 1.0 inch to accommodate different fuel generator configurations. The bore 710 may align with the boss from plate two to form a continuous pathway for gas transfer from the electrolysis cell to the chambers 708. In some embodiments, gas holes connect the bore 710 to the chambers 708, allowing passage of generated hydrogen and oxygen gas into the chamber 708.

In some embodiments, the chamber 708 is a hollow bore. In some embodiments, there are multiple chambers 708 arranged in a radial polar array within plate three 700 and configured to retain liquid. In the illustrated embodiment, the chambers 708 comprise four bores that function as bubbling chambers for anti-blowback during fuel generation. In some embodiments, the chambers 708 comprise two, three, five, six, or more hollow chambers depending on the gas production capacity requirements. In some embodiments, the chambers 708 are configured without liquid to function as dry gas collection chambers. In some embodiments, the chambers 708 are bubbling chambers. In some embodiments, generated gas passes through the port 706 into the chambers 708, where the gas bubbles rise through liquid residing in the chambers 708 before collecting in the upper portion of the chambers 708. In some aspects of the present technology, the chamber configuration prevents backflow of gas into the electrolysis cell during pressure fluctuations. In some embodiments, the method of generating fuel comprises transferring, through a second port, the hydrogen and oxygen gas into at least one bubbling chamber.

As further shown in FIGS. 7A-7G, the boss 702 may protrude from the top face of plate three 700 and align with a corresponding bore in plate four during assembly. In some embodiments, the boss 702 is 0.250 inches thick. In some embodiments, the boss 702 has a thickness ranging from 0.125 inches to 0.375 inches depending on the sealing and alignment requirements. The boss 702 provides precise positioning between plate three 700 and plate four while enabling proper sealing of the gas transfer pathway.

In some embodiments, the port 706 extends from the outer circumference of plate three 700 inward and provides fluid communication pathways within the assembled fuel generator. In some embodiments, plate three 700 includes a single port 706. In some embodiments, plate three 700 includes two or more ports 706 arranged around the outer circumference to provide multiple fluid access points to the chambers 708. In some embodiments, water is pumped into the chambers 708 until water flows out from the port 706.

In some embodiments, the assembly holes 704 are arranged in polar arrays through plate three 700. In the illustrated embodiment, the assembly holes 704 comprise an outer array of eight apertures and an inner array of four apertures. In some embodiments, the assembly holes 704 comprise six apertures in the outer array and three apertures in the inner array. The assembly holes 704 accommodate connection rods that pass through the plates and are secured with threaded fastener nuts to bind the disk plates together.

In some embodiments, the pin bore 712 is positioned at the center of plate three 700 and configured to accommodate a pressure differential pin that interacts with a valve assembly to regulate gas pressure within the fuel generator. In some embodiments, the pin bore 712 has a diameter that allows the pressure differential pin to slide freely in response to gas pressure buildup. Gas pressure acts on the bottom end surface of the pin, moving the pin upward into the valve stem of an assembly valve.

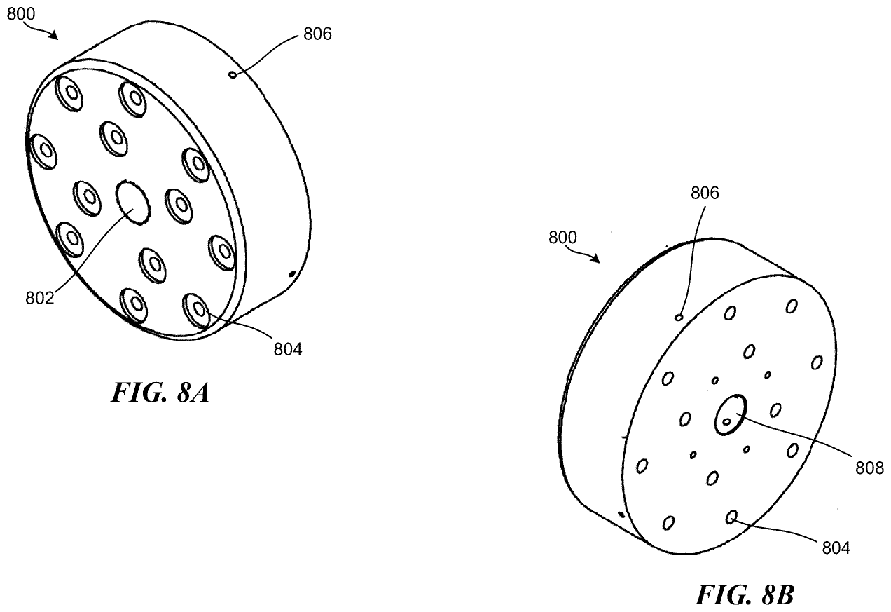

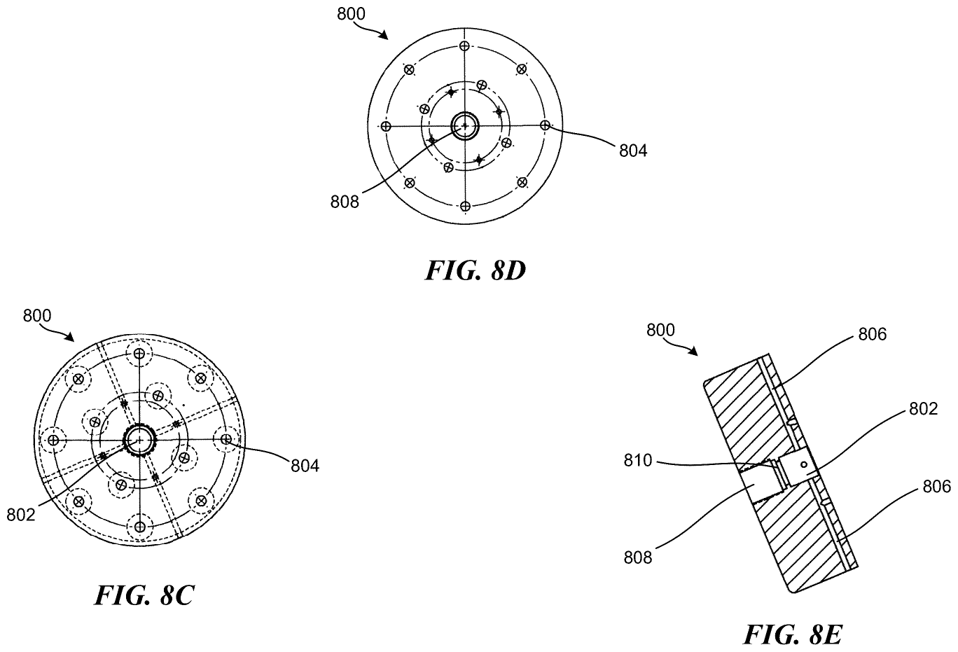

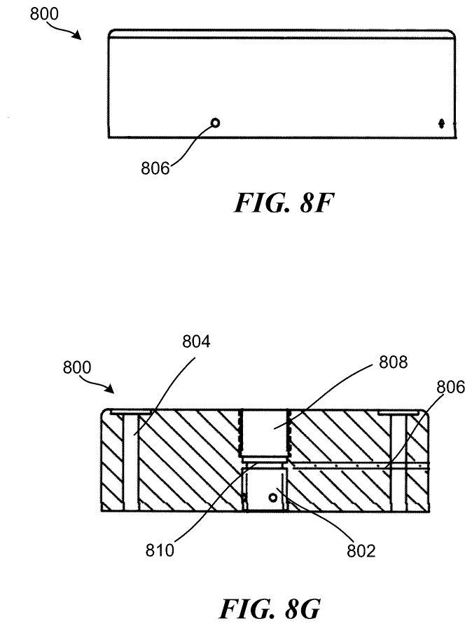

In some embodiments, such as illustrated in FIGS. 8A-8G, plate four 800 comprises a bore 802, 808, assembly holes 804, a port 806, and an outlet port 810. In some embodiments, plate four 800 forms the top portion of the fuel generator assembly and functions as a compressed gas distribution manifold. In the illustrated embodiment, plate four 800 is cylindrical in shape. In some embodiments, plate four 800 is cubic, octagonal, hexagonal, and/or another polygonal shape suitable for the fuel generator assembly. The components of plate four 800 may be constructed from materials selected for heat resistance, corrosion resistance, and structural integrity while internally pressurized from heating fuel production.

With continued reference to FIGS. 8A-8G, the bore 802 may be positioned centrally on the face of plate four 800 and configured to receive s boss from plate three 700 during assembly. In some embodiments, the bore 802 has a diameter of approximately 0.625 inches. In some embodiments, the bore 802 has a diameter ranging from 0.5 inches to 1.0 inch to accommodate different fuel generator configurations. The bore 802 may align with the boss 702 from plate three 700 to form a sealed connection between the bubbling chambers and the gas distribution manifold.

In some embodiments, the port 806 extends from the outer circumference of plate four 800 inward and provides access for gas transfer from individual chambers. The ports 806 may be used to transport gas, or to release water out of the system. In some embodiments, plate four 800 includes a single port 806. In some embodiments, plate four 800 includes two, three, four, or more ports 806 arranged around the outer circumference to provide multiple access points to the gas distribution manifold.

As further shown in FIGS. 8A-8G, the outlet port 810 may be configured to allow hydrogen and oxygen gas produced by the electrolysis cell to exit the fuel generator for usage. In some embodiments, the outlet port 810 has a diameter of approximately 0.25 inches. In some embodiments, the outlet port 810 has a diameter ranging from 0.125 inches to 0.5 inches depending on the gas flow rate requirements. Gas stored in the chambers of plate three continues through the bore 802 to the outlet port 810 for distribution.

In some embodiments, the assembly holes 804 are arranged in polar arrays through plate four 800. In the illustrated embodiment, the assembly holes 804 comprise an outer array of eight apertures and an inner array of four apertures. In some embodiments, the assembly holes 804 comprise six apertures in the outer array and three apertures in the inner array. In some embodiments, the assembly holes 804 comprise ten or more apertures in the outer array and six or more apertures in the inner array for larger fuel generator configurations. The assembly holes 804 accommodate connection rods that pass through the plates and are secured with threaded fastener nuts to bind the disk plates together. In some embodiments, at the top end of plate four 800, the assembly holes 804 have an end mill inset for seals at a depth of 0.075 inches.

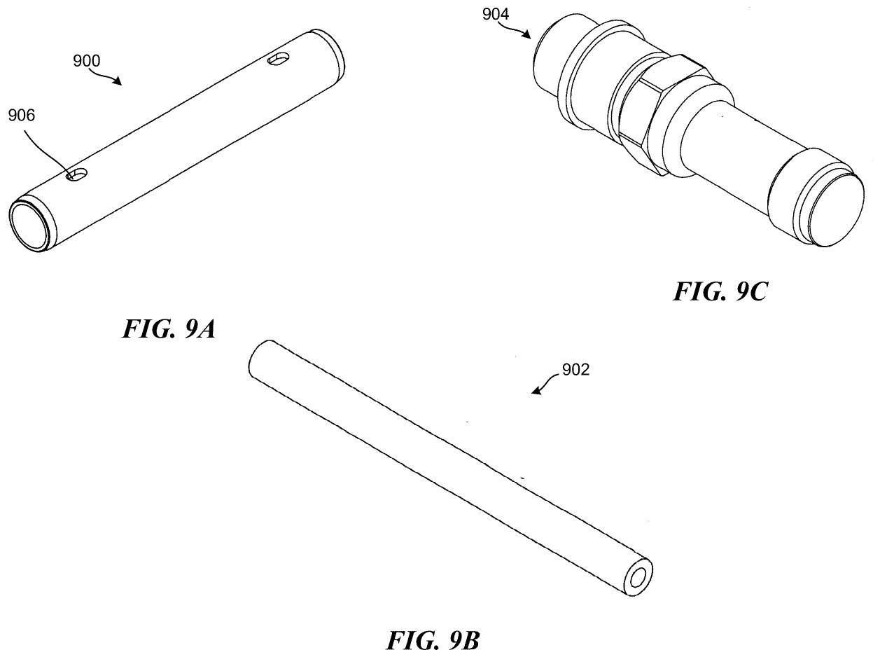

In some embodiments, such as illustrated in FIGS. 9A-9C, a tube 900, a rod 902, and an electrical conductor 904, form an electrolysis cell of the fuel generator. The tube 900 functions as one electrode in the electrolysis process, while the rod 902 functions as the other electrode. The electrical conductor 904 provides electrical connection to the tube 900 and the rod 902, enabling direct current to flow through the electrodes and facilitate the electrolysis reaction that splits water into hydrogen and oxygen gas. In some aspects of the present technology, the tube 900, rod 902, and electrical conductor 904 configuration enables efficient gas production through electrolysis when water fills the space between the tube 900 and the rod 902.

With reference to FIG. 9A, the tube 900 is an elongated component configured to function as an electrode in the electrolysis process. In some embodiments, the tube 900 is configured as an anode in the electrical circuit, while in other embodiments the tube 900 is configured as a cathode in the electrical circuit. In some embodiments, the tube 900 is configured to be either the cathode or the anode in the electrical circuit. The electrode configuration of the tube 900 may be adjusted based on gas production requirements and the desired ratio of hydrogen to oxygen gas output. In some embodiments, the tube 900 has an outer diameter of approximately 0.625 inches. In some embodiments, the tube 900 has an outer diameter ranging from 0.5 inches to 1.0 inch depending on the gas production capacity requirements. In some embodiments, the tube 900 has a wall thickness of approximately 0.0625 inches. In some embodiments, the tube 900 has a wall thickness ranging from 0.03125 inches to 0.125 inches, where increased wall thickness increases conductivity and gas production efficiency.

In some embodiments, the tube 900 is cylindrical in shape. In some embodiments, the tube 900 is hexagonal, octagonal, square, or another polygonal shape in cross-section. In some embodiments, the tube 900 is formed from a material compatible with electrolysis, such as aluminum, stainless steel, titanium, platinum, nickel, or copper. In some embodiments, the tube 900 has a chamfered end with dimensions of approximately 0.1 inches in length by 10 degrees for assembly purposes into O-ring groove bores. In some embodiments, the tube 900 has a length of approximately 4.375 inches. The length of the tube may vary to accommodate different fuel generator configurations.

As further shown in FIG. 9A, a port connection 906 may be positioned near one end of the tube 900 and provide fluid communication pathways that allow water to enter and exit the electrolyzer chamber during operation. In some embodiments, the port connection 906 comprise a slot positioned at 0.7 inches from the longitudinal centerline of the tube 900. In some embodiments, the port connection 906 has dimensions of approximately 0.125 inches wide by 0.250 inches long. In some embodiments, more than one port connection 906 is present. Port connections 906 may be positioned on opposing sides of the tube 900 to align with ports in plate one 500 and plate two 600 after assembly. In some embodiments, the port connections 906 comprise two, three, four, or more openings arranged around the circumference of the tube 900 to provide multiple fluid access points. The port connections 906 enable water to flow into the space between the tube 900 and the rod 902 for the electrolysis process.

In some embodiments, such as illustrated in FIG. 9B, the rod 902 is an elongated component configured to be centrally positioned within the tube 900. In some embodiments, the rod 902 is configured as a cathode in the electrical circuit, while in other embodiments the rod 902 is configured as an anode in the electrical circuit. In some embodiments, the rod 902 is configured to be either the cathode or the anode in the electrical circuit. The electrode configuration of the rod 902 may be adjusted based on gas production requirements and operates in conjunction with the tube 900 to facilitate electrolysis. In some embodiments, the rod 902 has a diameter of approximately 0.313 inches. In some embodiments, the rod 902 has a diameter ranging from 0.125 inches to 0.5 inches depending on the tube 900 inner diameter and the desired spacing between electrodes. In some embodiments, the rod 902 has a length of approximately 4.063 inches. In some embodiments, the rod 902 has a length ranging from 3 inches to 6 inches depending on the plate thickness and fuel generator configuration.

With continued reference to FIG. 9B, the rod 902 is a solid rod in some embodiments. In some embodiments, the rod 902 has a hollow center. In some embodiments, the rod 902 includes a bore in the center of one end with dimensions of approximately 0.161 inches in diameter by 0.150 inches deep for centrally locating the rod 902 within the tube 900 using a non-conductive sleeve. In some embodiments, the rod 902 is cylindrical in shape. In some embodiments, the rod 902 is hexagonal, octagonal, square, or another polygonal shape in cross-section. In some embodiments, the rod 902 is formed from a material compatible with electrolysis, such as aluminum, stainless steel, titanium, platinum, nickel, or copper.

In some embodiments, the rod 902 and the tube 900 are arranged such that the rod 902 and the tube 900 are not in direct contact with each other, maintaining electrical isolation between the two electrodes. In some embodiments, a non-conductive sleeve is positioned between the tube 900 and the rod 902 to centrally position the rod 902 within the tube 900 while preventing electrical contact. In some embodiments, the non-conductive sleeve is formed from plastic, ceramic, and/or rubber. The spacing between the rod 902 and the tube 900 provides a chamber for water to reside during the electrolysis process.

In some embodiments, a carbon rod or carbon tube is placed over the rod 212 and within the hollow tube 214. The carbon rod or carbon tube may increase conductivity between the electrodes, resulting in increased electrolysis and fuel production. Gas production may be increased or decreased by regulating the voltage applied to the electrical conductor 210. Higher voltage levels increase the rate of electrolysis and gas production, while lower voltage levels decrease gas production. In some embodiments, the carbon rod or carbon tube is configured as a sleeve that fits over the outer surface of the rod 212, providing an enhanced conductive layer while maintaining the structural support of the underlying rod 212. In some embodiments, the carbon rod or tube is integrated with the rod 212. In some embodiments, the carbon rod replaces the rod 212 entirely, with the carbon material serving as an electrode within the hollow tube 214.

In some embodiments, the electrical conductor 904 is configured to provide electrical current to the tube 900 and the rod 902. In some embodiments, such as shown in FIG. 9C, the electrical conductor 904 is a spark plug. In some embodiments, the electrical conductor 904 is a modified Champion RHM38E aviation spark plug. In some embodiments, the electrical conductor 904 is a custom-designed electrode connector, a bus bar, or another electrical connection device configured to deliver direct current to the tube 900 and the rod 902.

In some embodiments, the electrical conductor 904 includes an outer rim that interfaces with the tube 900 to provide electrical connection. In some embodiments, the electrical conductor 904 includes a center conductor that interfaces with the rod 902 to provide electrical connection. The electrical conductor 904 may be sealed to withstand high gas compression to the outside environment. In some embodiments, the electrical conductor 904 is threaded to M18×1.5 thread pitch for installation into a bore of plate one. In some embodiments, the electrical conductor 904 is threaded to other standard thread pitches depending on the bore configuration. In some embodiments, the electrical conductor 904 is formed from materials selected for electrical conductivity, corrosion resistance, and sealing capability under pressure.

### Filtration System

In some embodiments, such as illustrated in FIG. 10, the fuel generator system 1000 is configured to produce drinking water. In some embodiments, the fuel generator system 1000 comprises a filtration system 1002. The filtration system 1002 may be integrated into the fuel generator system 1000. In some embodiments, the filtration system 1002 is attached to the exterior of the fuel generator system 1000. Exterior connections to the fuel generation system 1000 allows the filtration system 1002 to be serviced by a user without disassembling the fuel generation system 1000. In some embodiments, the filtration system 1002 is configured to attach to the fuel generator system 1000 without requiring rotational pressure. The filtration system 1002 may be integrated with a port (such as the port 418 described in FIG. 4) so that water flowing from a water source 1004 into the fuel generator system 1000 passes through the filtration system 1002 before entering the fuel generator system 1000. In some embodiments, water passes through a filtration system 1002 when exiting the fuel generator system 1000. A filtration system 1002 may be present at each inlet and outlet port of the fuel generator system. Water that is not consumed by electrolysis to produce hydrogen gas and oxygen gas may flow out of the system for consumption. In some embodiments, the fuel generator system 1000 is configured to flow water through a magnetic field before it flows out of the system. In some embodiments, the fuel generator system 1000 is configured to produce purified air. Air 1006 passing into and/or out of the fuel generator system 1000 may flow through a filtration system 1002. In some embodiments, air 1006 and water from a water source 1004 are mixed. In some embodiments, natural air is mixed with oxyhydrogen (“HHO”) gas produced by electrolysis. The HHO gas may be combined with air at a 2% hydrogen to air ratio. In some embodiments, the purified air exits the fuel generator system 1000 from a separate exit port 1008 than the hydrogen gas and oxygen gas produced by electrolysis. In some embodiments, the purified air is mixed with air 1006 prior to or while exiting the fuel generator system 1000.

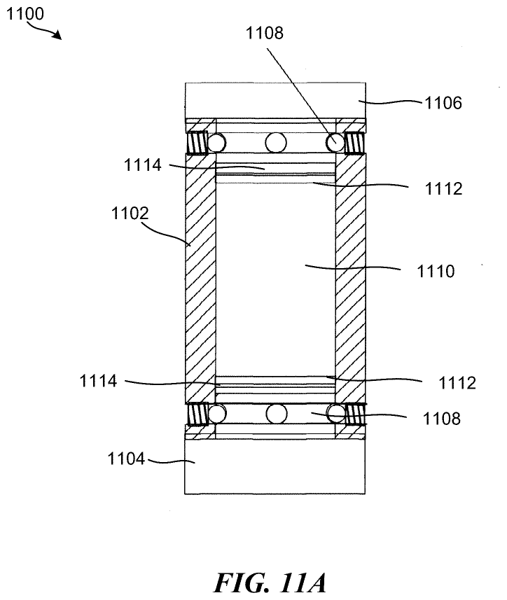

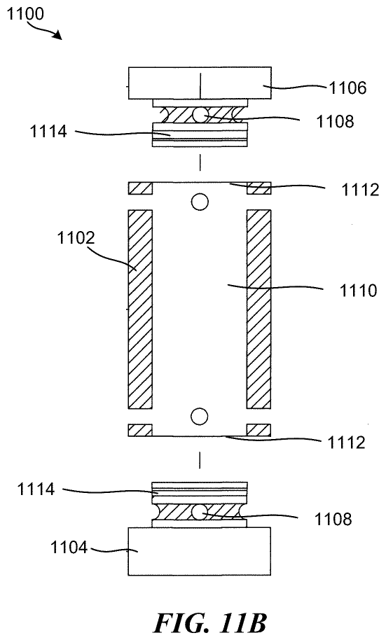

In some embodiments, such as illustrated in FIG. 11A and FIG. 11B, the filtration system 1100 comprises a filtration tube 1102 configured to be assembled with an inlet end plug 1104 and an outlet end plug 1106 using a locking mechanism 1108. In some embodiments, the filtration system 1100 only comprises an inlet end plug 1104 or an outlet end plug 1106. The filtration system may be operatively connected to a fuel generator system (such as the fuel generator system 1000 of FIG. 10). In some embodiments, the filtration tube 1102 has a hollow center 1110. The inlet end plug 1104 and/or outlet end plug 1106 may be configured to protrude into the hollow center 1110 of the filtration tube 1102. In some embodiments, the filtration tube comprises an O-ring on each end surface 1112 configured to seal liquid from the outside environment. In some embodiments, the inlet end plug 1104 and the outlet end plug 1106 each comprise an O-Ring configured to protrude into the hollow center 1110 of the filtration tube 1102. In some embodiments, the inlet end plug 1104 comprises a filter element 1114. In some embodiments, the outlet end plug 1106 comprises a filter element 1114. In some embodiments, the inlet end plug 1104 and the outlet end plug 1106 each comprise a filter element 1114. The filter element 1114 may be replaceable. In some embodiments, the filter element 1114 is replaceable without replacing the filtration system 1100. The filter element 1114 may comprise activated bamboo carbon, activated coconut carbon, carbonized non-activated bamboo, coconut charcoal, a carbon inlet filter, a carbon outlet filter and/or any other material suitable for filtration.

In some embodiments, the inlet end plug 1104 and the outlet end plug 1106 are configured to connect to the filtration tube 1102 using bearings and set screws. The components may be assembled or disassembled using an allen wrench. In some embodiments, the inlet end plug 1104, the outlet end plug 1106, and the filtration tube 1102 are connected without the use of threads on the outside of the housing or on the inside of a filter element 1114. In some embodiments, the inlet end plug 1104 and outlet end plug 1106 are configured to be rotated 360 degrees to a specific degree angle for assembly and disassembly to the filtration tube 1102. The specific degree angle may be adjusted to facilitate easy hook up and disassembly. The inlet end plug 1104 and/or the outlet end plug 1106 may be centrally aligned with the longitudinal axis of the filtration tube 1102.

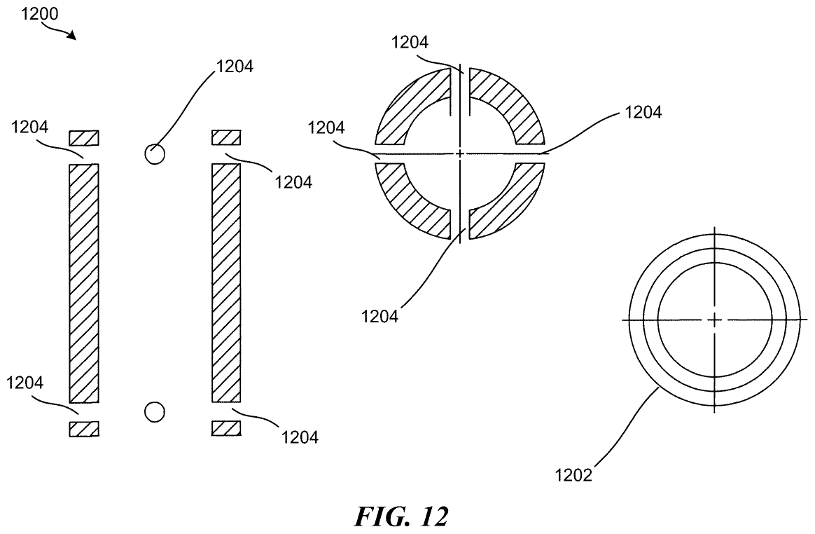

In some embodiments, such as illustrated in FIG. 12, a filtration body 1200 is configured to retain fluid. The filtration body 1200 may be pressurized when assembled. In some embodiments, the filtration body 1200 is machined from a solid stainless-steel rod. The filtration body may be made from stainless steel, aluminum, copper, tin, brass, and/or any other material suitable to store fluid. In some embodiments, the filtration body 1200 has an outer diameter of 2.25 inches and a 1.5 inch inside bore. In some embodiments, the filtration body has a wall thickness of about 0.375 inches. In some embodiments, the filtration body 1200 is four inches long. The dimensions of the filtration body 1200 may vary to accommodate different sized fuel generators and/or different configurations. In some embodiments, such as illustrated in FIG. 12, the filtration body 1200 comprises an O-ring 1202 configured to seal one end of the filtration body 1200 from outside elements. The filtration body 1200 may have multiple O-rings. In some embodiments, the filtration body 1200 comprises an O-ring 1202 at each end of the filtration body 1200.

In some embodiments, the filtration body 1200 has bore holes 1204 configured to allow ball bearings and/or screws to integrate with the filtration body during assembly with at least one end plug (such as the inlet end plug 1104 and/or outlet end plug 1106 described in FIGS. 11A and 11B). In some embodiments, such as illustrated in FIG. 12, there are four bore holes 1204 at each end of the filtration body 1200. The bore holes 1204 may be offset from adjacent holes by 90 degrees. In some embodiments, the bore holes 1204 have a diameter of 0.257 inches. The size of the bore holes 1204 may be adjusted to accommodate different sized filtration bodies 1200 and/or assembly components.

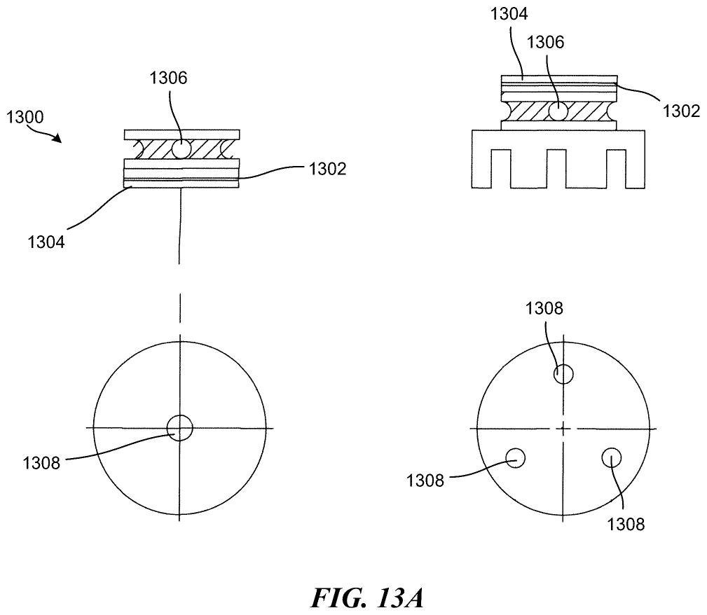

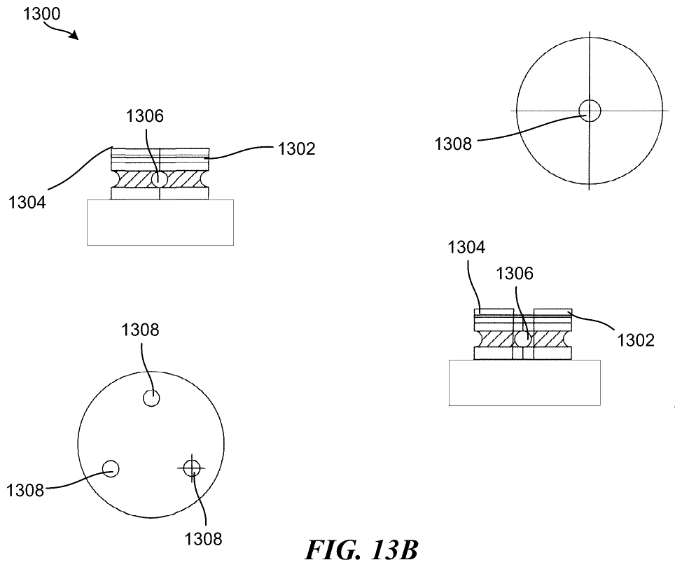

In some embodiments, such as illustrated in FIG. 13A and FIG. 13B, a filtration plug 1300 is configured to integrate with a filtration body (such as the filtration body 1200 described in FIG. 12A). The filtration plug 1300 may be an inlet end plug and/or an outlet end plug. In some embodiments, the filtration plug 1300 comprises a filtering element 1302. The filtering element 1302 may comprise activated bamboo carbon, activated coconut carbon, carbonized non-activated bamboo, coconut charcoal, a carbon inlet filter, a carbon outlet filter and/or any other material suitable for filtration. In some embodiments, the filtering element 1302 is configured to be replaceable without replacement of the filtration plug 1300. The filtering element 1302 may be configured to attach/detach from the filtration plug without the use of threads. In some embodiments, the filtration plug 1302 comprises an O-ring 1304. The O-ring 1304 may protrude from the filtration plug 1300 and be configured to fit into a hollow opening in a filtration body. In some embodiments, the filtration plug 1300 comprises at least one bore hole 1306 configured to allow the filtration plug to be assembled with a filtration body. The bore holes 1306 may be positioned at 90-degree angles from each adjacent bore hole 1306. In some embodiments, the bore hole has a diameter of 0.25 inches. The size of the bore hole may be adjusted to accommodate different configurations and different sizes of the filtration plug 1300. In some embodiments, the filtration plug 1300 comprises fluid bores 1308 configured to allow fluid to flow through the filtration plug 1300. The fluid bores 1308 may be configured vertically to allow fluid to flow through the filtration plug into a filtration body. There may be a single fluid bore 1308 or multiple fluid bores 1308. In some embodiments, there are three fluid bores 1308 positioned to form an equilateral triangle. In some embodiments, one filtration plug 1300 is an inlet end plug with three fluid bores 1308, while the other filtration plug 1300 is an outlet end plug with a single fluid bore 1308.

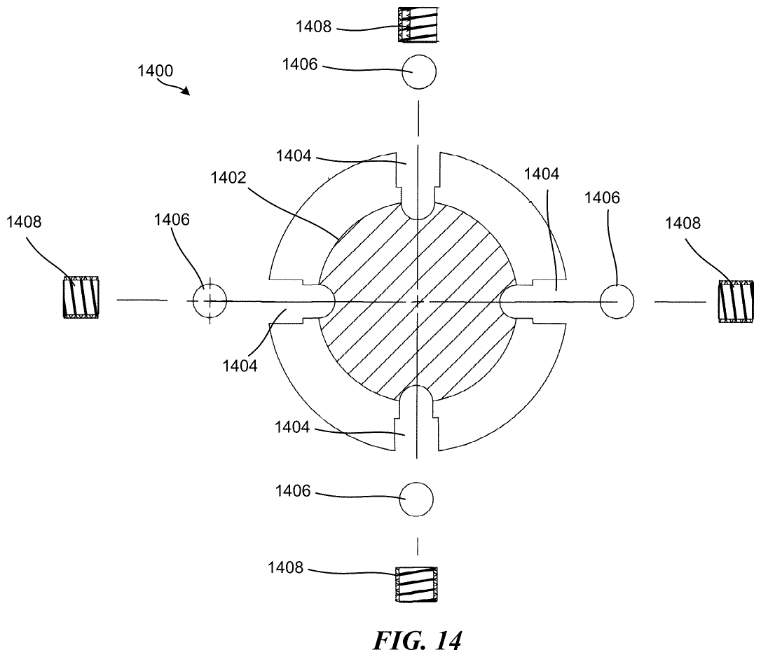

In some embodiments, such as illustrated in FIG. 14, a locking mechanism 1400 (e.g., the locking mechanism described in FIGS. 11A and 11B) is configured to connect a filtration body (such as a filtration body described in FIG. 12) with a filtration plug (such as a filtration plug described in FIG. 13A and FIG. 13B). In some embodiments, the locking mechanism 1400 comprises a manifold 1402 with a bore 1404 configured to fit a ball bearing 1406 and/or a screw 1408. In some embodiments, the locking mechanism 1400 is configured to allow a filtration plug to be rotated 360 degrees so that it can be easily aligned with the filtration body. A specific degree angle may be selected and/or altered to configure the assembly of the filtration plug with the filtration body. In some embodiments, the locking mechanism 1400 seal the filtration body and the filtration plug(s) together without the use of threads on the outside of the housing or the inside of a replaceable filter elements. The locking mechanism may be unlocked to replace the filter element without replacing the filtration plug and/or filtration body. In some embodiments, such as illustrated in FIG. 14, the locking mechanism 1400 comprises four ball bearings 1406 and four screws 1408. In some embodiments, the ball bearings 1406 have a radius of 0.25 inches and the screws 1408 are 5/16×18×¼ screws. The size of the ball bearings 1406 and/or the screws 1408 may be adjusted to accommodate different configurations and sizes of the locking mechanism 1400.

### Exemplary Methods

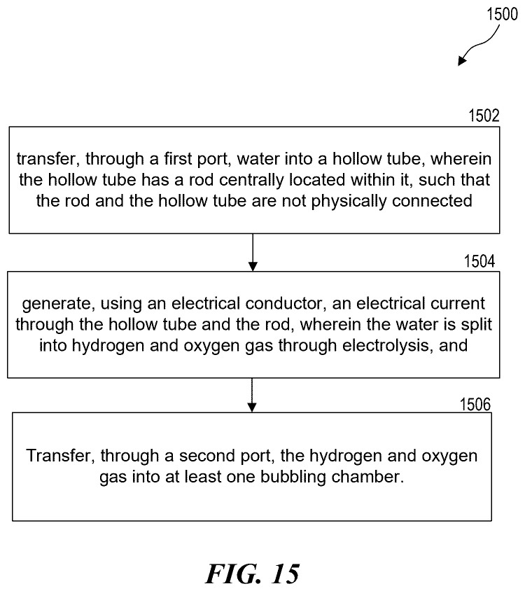

FIG. 15 is a flow diagram illustrating an example method 1500 of generating fuel. In some embodiments, the method 1500 is performed by components of the fuel generation system 200, as described in relation to FIG. 2 above. Likewise, embodiments can include different and/or additional operations or can perform the operations in different orders.

At operation 1502, water is transferred through a first port into a hollow tube. The water may be salt water, ionized water, tap water, ocean water, freshwater, and/or mineral water. In some embodiments, the hollow tube has a rod located within it, such that the rod and the hollow tube are not physically connected. In some embodiments, the rod and the hollow tube are separated by a non-conductive sleeve configured to position the rod in the center of the hollow tube. In some embodiments, the rod has a carbon tube placed around it to increase conduction through the water.

At operation 1504, an electrical current is generated through the rod and the hollow tube by an electrical conductor, wherein the water molecules are split into hydrogen gas and oxygen gas through electrolysis. In some embodiments, the electrical conductor is a spark plug. In some embodiments, the rod is the anode and the hollow tube is the cathode. In some embodiments, the hollow tube is the anode and the rod is the cathode. In some embodiments, the rod and the hollow tube can alternate between being the anode and the cathode. In some embodiments, the current from the electrical conductor can be increased or decreased to regulate the rate of electrolysis.

At operation 1506, the hydrogen and oxygen gas are transferred, through a second port, into a bubbling chamber. In some embodiments, the hydrogen gas and oxygen gas are transferred to the same bubbling chamber. In some embodiments, the hydrogen gas and the oxygen gas are transferred to different bubbling chambers. In some embodiments, there are four bubbling chambers arranged radially around the hollow tube and the rod. The bubbling chambers may be configured to allow water from the first port to fill the bubbling chambers in part. In some embodiments, the bubbling chambers are configured to prevent water from entering the bubbling chambers.

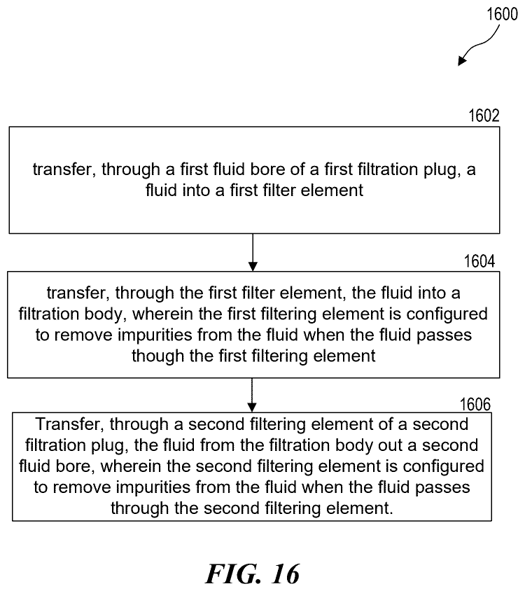

FIG. 16 is a flow diagram illustrating an example method 1600 of filtration. In some embodiments, the method 1600 is performed by components of the filtration system 1100, as described in relation to FIGS. 11A and 11B above. Likewise, embodiments can include different and/or additional operations or can perform the operations in different orders.

At operation 1602, fluid flows through a fluid bore of a filtration plug and into a first filter element. The fluid may be gaseous or a liquid. In some embodiments, the fluid is water. The water may be salt water, ionized water, tap water, ocean water, freshwater, and/or mineral water. In some embodiments, there are multiple fluid bores through which fluid flows. In some embodiments, there are three fluid bores positioned to form an equilateral triangle. The first filter element may comprise activated bamboo carbon, activated coconut carbon, carbonized non-activated bamboo, coconut charcoal, a carbon inlet filter, a carbon outlet filter and/or any other material suitable for filtration. In some embodiments, the first filter element is configured to be replaceable without replacing the filtration plug.

At operation 1604, fluid passes through the first filter element into a filtration body. In some embodiments, the filtration body is pressurized. The filtration body may be operatively connected to the filtration plug with a locking mechanism. In some embodiments, the locking mechanism attaches the filtration plug to the filtration body without the use of threads on the outside of the housing or the inside the first filter element. The locking mechanism may use ball bearings and screws to connect the filtration body and the filtration plug. In some embodiments, the locking mechanism is configured to allow the filtration plug to be rotated 360 degrees so that it can be easily aligned with the filtration body. A specific degree angle may be selected and/or altered to configure the assembly of the filtration plug with the filtration body. In some embodiments, the filtration body comprises UV lighting that kills bacteria, viruses, and/or mold in the fluid. In some embodiments, the filtration body is machined from a stainless-steel bar. The filtration body and/or filtration plug may comprise an O-ring configured to prevent outside contaminants from entering the filtration body.

At operation 1606, fluid passes through a second filter element and out a fluid bore. In some embodiments, the second filter element is the same type of filter element as the first filter element. In some embodiments, the second filter element is different than the first filter element. The second filter element may be enclosed within a filtration plug. In some embodiments, the second filter element is configured to be replaced without replacing the filtration plug enclosing it during use. The fluid bore may be a single bore or multiple bores. In some embodiments, the fluid bore is a single bore configured to transport fluid from the second filter element out of the filtration plug. In some embodiments, the water may be safely consumed after flowing through the fluid bore. In some embodiments, the fluid is transferred to a fuel generation system after flowing through the fluid bore.

In some embodiments, the fuel generator divides hydrogen gas from oxygen gas. In some embodiments, the hydrogen and oxygen gas are divided using a selective permeation membrane positioned within the gas transfer pathway. The selective permeation membrane allows hydrogen gas to pass through at a different rate than oxygen gas, enabling separation of the two gases into distinct chambers. In some embodiments, the selective permeation membrane is positioned between the electrolysis cell and the chambers of plate three, directing hydrogen gas to a first set of chambers and oxygen gas to a second set of chambers. In some embodiments, the selective permeation membrane comprises a polymer membrane, a palladium membrane, and/or a ceramic membrane configured for gas separation. In some embodiments, the fuel generator includes multiple outlet ports that connect to separate fuel reservoirs, allowing hydrogen gas and oxygen gas to be stored independently for different applications.

In some embodiments, gas produced by the fuel generator is combined with at least one additional gas. The at least one additional gas may be combined with the hydrogen gas and/or the oxygen gas. In some embodiments, the at least one additional gas is a gas that combines with hydrogen gas and/or oxygen gas to produce a combustible solution (e.g., carbon dioxide, methane, propane, butane, and/or carbon monoxide). In a preferred embodiment, hydrogen gas generated by the fuel generator combines with carbon dioxide to produce methane gas. The combination with at least one additional gas may comprise a chemical reaction and/or physical mixing. In some embodiments, the fuel generator is configured to produce hydrogen gas, oxygen gas, and at least one additional product. The at least one additional product may be a byproduct of electrolysis. In some embodiments, the at least one additional product is chlorine. In some embodiments, the at least one additional product is sodium. In some embodiments, the at least one additional product is salt. In some embodiments, the at least one additional product is combined with the hydrogen gas and/or oxygen gas. In some embodiments, the at least one additional product is separated from the hydrogen gas and/or oxygen gas. The at least one additional product may be transferred to a chamber or may remain in the electrolysis cell.

In some embodiments, the fuel generator is configured for continuous operation. A pump may draw water from a water source, such as an ocean, a lake, a river, or a storage tank, and delivers water to the fuel generator at a controlled flow rate. In some embodiments, the continuous water supply maintains consistent electrolysis conditions and enables prolonged fuel generation without manual intervention. In some embodiments, the fuel generator includes a flow control valve that regulates water flow rate based on gas production demand. In some embodiments, water is periodically pumped through the system at predetermined intervals to replenish water consumed during electrolysis and flush accumulated minerals or deposits from the electrolysis cell.

In some embodiments, multiple fuel generators are assembled in parallel to form a larger fuel generation system capable of meeting increased fuel demands. Each fuel generator in the parallel configuration may be connected to a common water supply line and a common electrical power source. In some embodiments, each fuel generator has a separate water supply and electrical power source. The hydrogen and oxygen gas produced by each fuel generator may flow into a shared manifold that combines gas output from all units. In some embodiments, the parallel fuel generation system includes two, three, four, five, ten, or more individual fuel generators, depending on the fuel demand requirements. In some aspects of the present technology, the parallel configuration enables fuel production sufficient to supply heating and cooking needs for larger systems, such as a house, a commercial building, an apartment complex, or an industrial facility.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A fuel generator, comprising:
an electrical conductor;
a hollow tube electrically connected to the electrical conductor;
a rod electrically connected to the electrical conductor,
wherein the rod is positioned within the hollow tube, and wherein the rod and the hollow tube are electrically isolated from each other;
a fluid port,
wherein the fluid port is operatively connected to the hollow tube, and wherein the fluid port is configured to allow water to enter a space between the rod and the hollow tube; and
a chamber,
wherein the chamber is operatively connected to the space between the rod and the hollow tube, and wherein the chamber is configured to receive gas generated within the hollow tube.

2. The fuel generator of claim 1, further comprising a non-conductive sleeve positioned in the space between the rod and the hollow tube and configured to centrally position the rod within the hollow tube.

3. The fuel generator of claim 1, wherein the rod is configured as a cathode and the hollow tube is configured as an anode in an electrical circuit.

4. the fuel generator of claim 1, wherein the chamber is a first chamber, further comprising a pressure differential pin and a pressure differential valve configured to evenly distribute pressure created by gas between the first chamber and a second chamber.

5. the fuel generator of claim 1, wherein the fuel generator comprises a plurality of machined plates assembled using fastener nuts and connection rods.

6. the fuel generator of claim 5, wherein the plurality of machined plates are created from a single aluminum bar.

7. the fuel generator of claim 1, further comprising a support base.

8. The fuel generator of claim 1, further comprising a carbon tube positioned within the hollow tube and around the rod, wherein the carbon tube is configured to increase electrical conduction through the water.

9. A method of generating fuel, comprising:
transferring, through a first port, water into a hollow tube,
wherein the hollow tube has a rod centrally located within it, such that the rod and the hollow tube are not physically connected;
generating, using an electrical conductor, an electrical current through the hollow tube and the rod,
wherein the water is split into hydrogen and oxygen gas through electrolysis; and
transferring, through a second port, the hydrogen gas and the oxygen gas into at least one bubbling chamber.

10. The method of generating fuel of claim 9, the method further comprising:
distributing, using a pressure differential pin and a pressure differential valve, the hydrogen gas and the oxygen gas evenly between the at least one bubbling chamber.

11. The method of generating fuel of claim 9, wherein the water is ocean water.

12. The method of generating fuel of claim 9, further comprising:
dividing, using a selective permeation membrane, the hydrogen gas from the oxygen gas.

13. The method of generating fuel of claim 9, wherein the electrical conductor is a spark plug.

14. A fuel generation system, comprising:
An electrical conductor;
A hollow tube electrically connected to the electrical conductor;
A rod electrically connected to the electrical conductor,
wherein the rod is positioned within the hollow tube, and wherein the rod and the hollow tube are electrically isolated from each other;
a power source,
wherein the power source is operatively connected to the electrical conductor and configured to provide electrical energy to the electrical conductor; and
a water source,
wherein the water source is operatively connected to a space between the hollow tube and the rod by a fluid port such that water from the water source fills the space between the hollow tube and the rod, and
wherein, upon receiving electrical energy from the power source, the electrical conductor, the hollow tube, and the rod split water molecules into hydrogen gas and oxygen gas through electrolysis.

15. The fuel generation system of claim 14, wherein the power source is a battery cell bank.

16. The fuel generation system of claim 14, wherein the power source is a solar panel.

17. The fuel generation system of claim 14, wherein the power source comprises a battery and an energy generation source.

18. The fuel generation system of claim 14, wherein the water source is salt water.

19. The fuel generation system of claim 14, wherein the electrical conductor is a spark plug.

20. The fuel generation system of claim 14, further comprising a non-conductive sleeve positioned between the hollow tube and the rod and configured to centrally position the rod within the hollow tube.
